(19) United States
(12) Patent Application Publication
(10) Pub. No.: US 2026/0108884 A1
(43) Pub. Date: Apr. 23, 2026

(54) FLUIDIC MODULE AND METHOD FOR GENERATING SPATIALLY SEPARATED LIQUID PARTITIONS

(71) Applicant: Hahn-Schickard-Gesellschaft für angewandte Forschung e.V., Stuttgart (DE)

(72) Inventors: Peter JÜLG, Freiburg (DE); Julian MENGES, Mannheim (DE); Salman MURAD, Freiburg (DE); Nils PAUST, Freiburg (DE); Tobias HUTZENLAUB, Ettenheim (DE)

(21) Appl. No.: 19/424,307

(22) Filed: Dec. 18, 2025

Related U.S. Application Data
(63) Continuation of application No. PCT/EP2024/067480, filed on Jun. 21, 2024.

(30) Foreign Application Priority Data
Jun. 26, 2023 (DE) 10 2023 205 997.5

(51) Int. Cl. B01L 3/00

(52) U.S. Cl. CPC B01L 3/502753; B01L 3/502746

(57) ABSTRACT

Fluidic module and method for generating spatially separated liquid partitions in an arrangement of recesses formed in a surface. The method comprises providing the fluidic module and rotating the fluidic module. The fluidic module comprises a fluid chamber that comprises the surface in which the arrangement of recesses is formed. Rotating the fluidic module takes place about a centre of rotation in order to exert a centrifugal force on a liquid through which the liquid is introduced into the fluid chamber and through which at least part of the liquid is transported from radially outside to radially inside across the arrangement of recesses. The method further comprises removing the liquid from areas of the surface outside the recesses in order to generate the spatially separated liquid partitions of the liquid in the recesses.

### CROSS-REFERENCE TO RELATED APPLICATIONS

This application is a continuation of copending International Application No. PCT/EP2024/067480, filed Jun. 21, 2024, which is incorporated herein by reference in its entirety, and additionally claims priority from German Application No. 10 2023 205 997.5, filed Jun. 26, 2023, which is also incorporated herein by reference in its entirety.

The present invention relates to fluidic modules and to methods for generating spatially separated liquid partitions that enable controlled transportation of liquid over an arrangement of recesses counter to a centrifugal force. The invention relates in particular to such devices and methods that are suitable for handling liquids in a centrifugal-microfluidic system.

### BACKGROUND OF THE INVENTION

Digital assays, such as, for example, digital PCR (dPCR), are essential technologies for the absolute and reference-free quantification of nucleic acids or other molecules or particles in unknown specimens [Witters_2014]. A further typical application for digital reactions is the marking (barcoding) of individual analytes such as nucleic acids or cells in order to be able to draw a conclusion pertaining to the initial analytes in a later process step [Kivioja_2012]. Carrying out a digital assay typically involves the partitioning of a reaction liquid into a multitude of sub-volumes. Depending on the application, there is the significant difference in the number of partitions (typically several 10 000 to several million partitions) and in the volume of an individual partition (typically in the picolitre to nanolitre range). A combination of partitions of different sizes can also be intended in order to implement digital assays, for example in order to expand the dynamic range of an assay [Schulz_2021]. However, the same challenge applies to most digital assays: the precision and reproducibility of the generated partitions in terms of number, volume and stability is decisive in terms of the performance capability of the digital assay. A further performance parameter is an ideally minor dead volume, thus that proportion of the reaction liquid which is lost in the system and is not available for analysis in the partitions. The dead volume is derived from the difference between the input volume of the reaction liquid and the analysed volume:

$${V}_{dead} = {V}_{input} - {V}_{analysis}$$

A large dead volume has a dual negative effect:
It reduces the proportion of the specimen which is analysed as a constituent part of the reaction liquid. In the case of rare analytes, such as, for example, specific mutations in the analysis of cell-free DNA, a large dead volume can have the consequence that the target analyte is not located in the analysed partitions but in the non-analysed dead volume and thus a false-negative or at least an excessively minor signal is measured.
Moreover, a large dead volume means an unnecessarily large input of often very costly reagents, for example polymerases in a PCR mix or antibodies in an ELISA mix.

A widely used method is generating partitions by means of emulsions, i.e. by means of so-called droplet microfluidics [Teh_2008]. In this context too, there are already studies based on centrifugal microfluidics [Schuler_2015]. Several commercialized systems for digital assays are likewise based on droplet microfluidics methods [Bio-Rad_2023; Stilla_2023]. Droplet-based systems are often characterized by minor dead volumes, however have a plurality of technical disadvantages:
Instability of the droplets in relation to coalescence, for example under thermal input in the course of a PCR thermocycling protocol.
Instability of the droplets under mechanical load (shear forces), for example due to gas bubbles which are created as a result of a temperature increase and move through the accumulation of droplets.
Compatibility issues of, for example, proteins or enzymes with the needed detergents for stabilizing the droplets.

The alternatives to droplet-based systems are geometrically defined systems, typically referred to as well arrays, micro wells or nano wells [Liao_2017]. Analogous to the droplet-based systems, here too there are already several commercialized systems [QIAGEN_2023; Quanterix_2023; ThermoFisher_2023_1; Fluidigm_2023; JN-MEDSYS_2023; Roche_2023; Illumina_2023]. By the partitioning by means of geometrically defined recesses (so-called wells) incorporated into the fluidic module, the afore-mentioned issues of the droplet-based systems can be circumvented:
The use of detergents for stabilizing in relation to coalescence is typically no longer needed, because the walls of the recesses already sufficiently generate mechanical stability of the partition.
Shear forces due to temperature-induced formation of gas bubbles have reduced effects on the compartments, because gas bubbles when being transported away through the oil either do not come into contact with the wells or if at all then only marginally.

Apart from solving droplet-associated issues, the following advantages are moreover derived from geometric partitioning by means of recesses in the fluidic module:
The option of pre-storing reagents, for example primers for a digital PCR
The highly simplified optical evaluation of the partitions as a result of the defined geometric arrangement, for example during fluorescence evaluation at the end of a digital PCR

There are already various systems which utilize geometric partitioning by means of recesses. However, the existing systems suffer from at least one of the following disadvantages:
For many of the available systems, the chips (typically single-use products) are manufactured in glass or silicon by means of photolithographic processes. This results in high production costs per chip [Illumina_2023; ThermoFisher_2023_2; JN-MEDSYS_2023, Podbiel_2021, Henley_2020].
Filling the recesses often takes place by way of a network of supply channels. The supply channels define, inter alia, the dead volume of the system and are therefore typically kept small in terms of the cross section. This in turn causes a high flow resistance which limits the filling rate. A further issue of channel networks with a small cross section is the undesirable adsorption of biomolecules on the channel walls, so that the latter are no longer available for the analysis in the partitions. Furthermore, the supply channels limit the achievable integration density of partitions [QIAGEN_2023; ThermoFisher_2023_1; Fluidigm_2023; U.S. Pat. No. 8,277,759B2; U.S. Pat. No. 9,487,822B2, EP3357575B1]
Filling the recesses takes place by targeted utilization of capillary forces. This involves the local hydrophilization and/or hydrophobization of the fluidic module, which cause additional costs in the production of the chips [U.S. Pat. No. 10,967,370B2] [Roche_2023].
The only known system which dispenses with expensive chip materials such as glass or silicon as well as with supply channels by implementing planar flushing by applying a vacuum and thus filling the recesses is the Quanterix Simoa System [Quanterix_2023]. However, the latter comprises a very large dead volume. This is caused by a large gap (height: 500 μm) between the recesses (height: 3.25 μm, diameter: 4.25 μm, distance between centres: 8 μm) and the opposite chamber side. The dead volume exceeds the analysed volume of a specimen by significantly more than the factor 100 [2012_Kan].

Devices and methods for immobilizing objects in terms of examination locations by means of pressure or vacuum are known from WO 2021/211754 A2. A centrifugal force is used to remove liquid from a chamber.

Described in WO 2012/103447 A1 are systems, devices and/or methods which relate to introducing a multitude of spheres in testing locations, sealing testing locations and imaging testing locations. The objects are introduced into the testing locations, for example, by means of a magnetic field generator which generates a relative movement between magnetic objects and the testing locations. Once objects have been introduced into testing locations of a first chamber, the device is rotated by one position in order to introduce further objects into testing locations of a further chamber.

Furthermore, there exists a device [2010_Rissin] in which a short piece of PVC tubing is placed on an etched end of a fibre bundle in order to achieve a reservoir for a particle solution which is pipetted into this reservoir. The fibre bundle is then centrifuged for 10 minutes at 1300 g in order to force the particles into the etched recesses.

In view of the above, there is a need for a concept which enables a better compromise between an improvement in terms of precision and reproducibility in a spatial separation of liquids and a reduction of a dead volume. Furthermore, despite high precision and reproducibility, it is an object to achieve a rapid and efficient separation of liquids with little loss of material to be analysed, such as particles or molecules. Additionally, a reduction in terms of costs is desirable.

### SUMMARY

According to an embodiment, a method for generating spatially separated liquid partitions in an arrangement of recesses formed in a surface may have the steps of: providing a fluidic module; rotating the fluidic module including a fluid chamber that includes the surface in which the arrangement of recesses is formed, about a centre of rotation in order to apply a centrifugal force on a liquid through which the liquid is introduced into the fluid chamber and through which at least part of the liquid is transported from radially outside to radially inside across the arrangement of recesses; and removing the liquid from areas of the surface outside the recesses to generate the spatially separated liquid partitions of the liquid in the recesses.

According to another embodiment, a fluidic module for generating spatially separated liquid partitions while using an inventive method may have: the fluid chamber that includes the surface in which the arrangement of recesses is formed; inlet structures which are designed, during rotation of the fluidic module, to introduce liquid into the fluid chamber by means of centrifugal force in order to transport the liquid from radially outside to radially inside across the arrangement of recesses; and outlet structures which are designed, after a flow has passed over the surface in which the arrangement of recesses is formed, to remove the same liquid from areas of the surface outside the recesses in order to generate the spatially separated liquid partitions of the liquid in the recesses.

Another embodiment may have a device for performing a method for generating spatially separated liquid partitions in an arrangement of recesses formed in a surface, the method having the steps of: providing a fluidic module; rotating the fluidic module including a fluid chamber that includes the surface in which the arrangement of recesses is formed, about a centre of rotation in order to apply a centrifugal force on a liquid through which the liquid is introduced into the fluid chamber and through which at least part of the liquid is transported from radially outside to radially inside across the arrangement of recesses; and removing the liquid from areas of the surface outside the recesses to generate the spatially separated liquid partitions of the liquid in the recesses, including: an inventive fluidic module; a drive installation for rotating the fluidic module.

The present invention proceeds from partitioning liquids by means of geometrically defined recesses which are incorporated into the fluidic module. In this context, the inventors have established that controlled filling of a fluid chamber and of the recesses disposed therein is made possible by means of centrifugal force. This is based on the knowledge that, by means of the centrifugal force, a defined liquid front within the fluid chamber can be implemented and as a result, when filling the fluid chamber counter to the centrifugal force from radially outside to radially inside, the dissipation of the liquid within the fluid chamber can be controlled. A further advantage of filling by means of centrifugal force lies in that capillary forces within the fluid chamber become negligible, and as a result a chamber height can be reduced and thus also a dead volume can be minimized, on the one hand, and an undesirable inclusion of air bubbles in the area of the recesses can be avoided or reduced, on the other hand. This increases the proportion of liquid that lands in the recesses and can be analysed. Thus, high precision and reproducibility is achieved in a spatial separation of liquids.

One embodiment relates to a method for generating spatially separated liquid partitions in an arrangement, for example an array or a pattern, of recesses, for example wells, formed in a surface. The method comprises providing a fluidic module and rotating the fluidic module. The fluidic module comprises a fluid chamber that comprises the surface in which the arrangement of recesses is formed. Rotating the fluidic module takes place about a centre of rotation in order to exert a centrifugal force on a liquid through which the liquid is introduced into the fluid chamber and through which at least part of the liquid is transported from radially outside to radially inside across the arrangement of recesses. The method furthermore comprises removing the liquid from areas of the surface outside the recesses to generate the spatially separated liquid partitions of the liquid in the recesses.

In embodiments, the liquid in the areas outside the recesses is removed from the fluid chamber by way of an outlet, by rotating the fluidic module. The rotation during the removal of the liquid can take place so as to correspond to the rotation during the introduction of the liquid, i.e. take place at the same rotational frequency, for example, and/or take place by continuing the rotation during the introduction of the liquid, for example take place without interrupting the rotation between the introduction of the liquid and the removal of the liquid. Alternatively, the fluidic module can be impinged with a rotational frequency which is increased in comparison to a rotational frequency when introducing the liquid into the fluid chamber. As a result of the rotation of the fluidic module, the liquid that is not disposed in the recesses can be ejected from the fluid chamber. Since the centrifugal force acting on the minor liquid volumes remaining in the recesses is smaller than the capillary forces acting on said liquid volumes, the liquid remains in the recesses. As a result, the spatially separated liquid partitions are generated in a very efficient and reproducible manner.

Optionally, after the removal, a second liquid which cannot be homogenously mixed with the liquid can be introduced into the fluid chamber by rotating the fluidic module in order to seal the recesses with the liquid partitions contained therein. The rotational frequency when introducing the second liquid can correspond to the rotational frequency when introducing the liquid. By sealing the liquid partitions with the second liquid by means of rotating the fluidic module, the liquid partitions are efficiently separated from one another. It is thus avoided that two liquid partitions are fluidically coupled to one another by way of residual liquid potentially remaining on the surface. This allows high precision to be achieved when analysing the liquid partitions, because sealing by means of the second liquid ensures precise defined liquid volumes in the recesses.

In embodiments, the complete fluid chamber with the exception of the recesses is first emptied, i.e. the liquid in the areas outside the recesses is completely removed from the fluid chamber by way of the outlet by rotating the fluidic module before the second liquid is introduced. As a result, higher precision is achieved in the separation of the liquid partitions than if the liquid in the areas outside the recesses is removed from the fluid chamber by way of the outlet by means of introducing the second liquid.

In embodiments, the fluid chamber forms a gap between the surface in which the arrangement of recesses is formed and a surface lying opposite this surface. A gap height of the gap is, for example, at most 10 times a depth of the recesses, and/or the gap height is at most 200 μm, advantageously at most 100 μm. The gap height and the depth describe dimensions or extents perpendicular to the surface in which the recesses are disposed. Rotating the fluidic module takes place at such a rotating speed that the centrifugal force acting on the liquid volume is greater than the capillary force acting on the liquid in the gap. The rotating speed is, for example, at least 30 Hz, advantageously at least 40 Hz. Owing to the fact that the centrifugal force is greater than the capillary force, in contrast to capillary filling in which the liquid would move to where the highest capillary pressure prevails, a uniform liquid front can be achieved by way of which filling of the recesses is possible in a controlled manner even at a minor gap height. The capillary forces which could otherwise interfere with the defined filling procedure, for example by including air bubbles in the area of the recesses due to non-uniform transport of the liquid within the fluid chamber, i.e. during transport across the arrangement of recesses, can be neglected. Moreover, high precision and reproducibility in the generation of liquid partitions is achieved by the avoidance of trapped air. Apart from the rotating speed, the centrifugal force is also a function of radial filling levels, for example. The radial filling levels are defined, for example, by the liquid volume and the chamber geometries and/or channel geometries. The radial filling levels are designed by liquid volume and chamber geometries and/or channel geometries in such a manner, and rotating the fluidic module takes place at such a rotating speed, that the centrifugal force acting on the liquid volume is greater than the capillary force acting on the liquid in the gap. It is particularly advantageous when the centrifugal force acting on the liquid volume is greater than a capillary force acting on the liquid in the gap by a factor of at least five, advantageously at least ten.

In embodiments, a liquid flow into the fluid chamber is limited when introducing the liquid into the fluid chamber. This is based on the knowledge that, at the beginning of the rotation of the fluidic module, for example when starting a centrifuge which comprises the fluidic module, the rotational frequency is slowly increased and a desired rotational frequency is not instantaneously achieved. So that the rotation of the fluidic module about the centre of rotation takes place at a rotational frequency at which a centrifugal force is exerted on the liquid through which at least part of the liquid is transported from radially outside to radially inside across the arrangement of recesses, it is advantageous to limit the liquid flow into the fluid chamber. As a result of the flow limitation, the desired rotational frequency is reached before the liquid reaches the recesses. In this way, a predetermined rotational frequency for transporting the liquid across the arrangement of recesses can be achieved before the liquid reaches the arrangement. As a result, controlled transportation of the liquid across the arrangement of recesses can be achieved, because a correspondingly high rotational frequency prevails during transportation, for example. This guarantees precise and reproducible filling of the recesses. During the introduction of the liquid, i.e. during the filling procedure, the rotating speed does not have to be constantly kept at a predetermined rotating speed. However, it is advantageous when the rotating speed already has a certain value, i.e. at least reaches the predetermined rotating speed, for example the 30 to 40 Hz mentioned above.

In embodiments, it is prevented by limiting the liquid flow into the fluid chamber that the liquid in the fluid chamber reaches the arrangement of recesses before the centrifugal force acting on the liquid volume is greater than the capillary force acting on the liquid in the gap. It is particularly advantageous when the centrifugal force acting on the liquid volume is greater than the capillary force acting on the liquid in the gap by a factor of at least five or ten. Owing to the high centrifugal force in comparison to the capillary force, the precision during filling is improved because the liquid is thus transported from radially outside to radially inside by way of a controlled liquid front across the arrangement of recesses and because the probability that air bubbles are included in the liquid during this transport is thus reduced.

The limitation of the liquid flow can take place in various ways. The inventors consider the use of an inlet resistance channel or of a pneumatic counter pressure in the fluid chamber or of a pneumatic vacuum in the inlet chamber to be particularly advantageous.

In embodiments, the fluidic module comprises an inlet resistance channel which opens into the fluid chamber in order to limit the liquid flow into the fluid chamber. The cross section and the length of the inlet resistance channel are designed in such a way, for example, that a predetermined rotational frequency during the rotation of the fluidic module is reached before the liquid reaches the recesses in the fluid chamber. The inlet resistance channel comprises, for example, a small cross section, for example a diameter or a height and/or width of a few ten μm, advantageously of at most 100 μm, 50 μm, 30 μm, 20 μm or 10 μm. The small cross section causes a flow resistance which limits the filling rate. The inventors have recognized that, despite the disadvantages of a channel with a small cross section, such as the undesirable adsorption of molecules on the channel walls, an inlet resistance channel with a small cross section is advantageous in the present case, because controlled filling of the recesses can be implemented as a result. The undesirable adsorption of molecules on the channel walls is moreover minimized because connection channels between the recesses are not required, and the inlet resistance channel can be kept short. As opposed to channel networks with a small channel cross section, a large number of recesses can be very rapidly filled with the liquid in the present case, despite the inlet resistance channel, because the liquid is transported in a planar manner across the arrangement of recesses and resistances in supply channels of individual recesses are dispensed with. As a result, a positive compromise between minimizing the issues due to adsorption of biomolecules on channel walls and a rapid and precise generation of liquid partitions is achieved.

In embodiments, a pneumatic counter pressure is generated in the fluid chamber in order to limit the liquid flow into the fluid chamber. As a result, for example, the liquid is transported in the direction of the fluid chamber only when the centrifugal force acting on the liquid exceeds the pneumatic counter pressure. The pneumatic counter pressure can be set in such a way that the liquid reaches the recesses within the fluid chamber only when a predetermined rotational frequency, or a predetermined centrifugal force acting on the liquid, is reached during the rotation of the fluidic module. Limiting the liquid flow by means of pneumatic counter pressure not only has the advantage that, by reaching the predetermined rotational frequency, the liquid is transported from radially outside to radially inside by way of a controlled liquid front across the arrangement of recesses, but moreover that adsorption of biomolecules on channel walls can be minimized or avoided, because an inlet channel which opens into the fluid chamber and comprises a small cross section can be dispensed with.

In embodiments, the pneumatic counter pressure is caused by flow-restricted ventilation of the fluid chamber. For example when introducing the liquid into the fluid chamber, an overpressure that limits the liquid flow into the fluid chamber is created by means of the flow-restricted ventilation in said fluid chamber. For example, less air per unit of time escapes from the fluid chamber by way of the flow-restricted ventilation than there is liquid transported in the direction of the fluid chamber. The flow-restricted ventilation is designed in such a way, for example, that the liquid reaches the recesses within the fluid chamber only when a predetermined rotational frequency, or a predetermined centrifugal force acting on the liquid, is reached when rotating the fluidic module.

In embodiments, a pneumatic vacuum is generated in the inlet chamber in order to limit the liquid flow into the fluid chamber. As a result, the liquid is transported in the direction of the fluid chamber with the delay, for example. The pneumatic vacuum can be set in such a way that the liquid reaches the recesses within the fluid chamber only when a predetermined rotational frequency, or a predetermined centrifugal force acting on the liquid, is reached when rotating the fluidic module. Limiting the liquid flow by means of pneumatic vacuum not only has the advantage that, by reaching the predetermined rotational frequency, the liquid is transported from radially outside to radially inside by way of a controlled liquid front across the arrangement of recesses, but moreover that adsorption of biomolecules on channel walls can be minimized, because a small cross section of the inlet channel which opens into the fluid chamber can be dispensed with.

In an embodiment, the pneumatic vacuum is caused by flow-restricted ventilation of the inlet chamber. For example when introducing the liquid into the fluid chamber, or when transporting the liquid from the inlet chamber into the fluid chamber, a vacuum which limits the liquid flow into the fluid chamber is created by means of the flow-restricted ventilation in the inlet chamber. For example, less air per unit of time is introduced in the inlet chamber by way of the flow-restricted ventilation than there is liquid transported out of the inlet chamber in the direction of the fluid chamber. The flow-restricted ventilation is designed in such a way, for example, that the liquid reaches the recesses within the fluid chamber only when a predetermined rotational frequency, or a predetermined centrifugal force acting on the liquid, is reached when rotating the fluidic module.

In embodiments, a volume-controlled switch which is fluidically coupled to an outlet of the fluid chamber is used. The volume-controlled switch enables emptying of the fluid chamber, i.e. removing the liquid from areas of the surface outside the recesses, only once the arrangement of recesses has been completely passed over by a flow of the liquid, or the fluid chamber has been completely filled. For example, the volume-controlled switch can be designed as an inverted siphon, the apex of which lies radially further inside than the radially inner end of the array of recesses. For example, the volume-controlled switch can be designed in the form of a siphon which at a radially outermost point of the fluid chamber is fluidically coupled to the latter. For example, the siphon runs parallel to the fluid chamber proceeding from the outlet, i.e. from the radially outermost point of the fluid chamber, radially inwards at least up to a radially innermost point of the arrangement of recesses before the siphon changes its direction and runs radially outwards. As a result, a radial filling level of the siphon mirrors a radial filling level of the chamber and enables emptying of the fluid chamber only once the arrangement of recesses has been completely passed over by a flow of the liquid, because a radially innermost point, for example an apex, of the siphon is reached only when the arrangement of recesses has been completely passed over by a flow of the liquid. Filling of all recesses of the arrangement can be very efficiently ensured by the volume-controlled switch. At the same time, the volume-controlled switch can be designed in such a way that only a very small dead volume is created, this enabling savings in terms of valuable specimens or costly reagents, for example as a result of a small cross section of the siphon.

In embodiments, as an alternative to the volume-controlled switch, an outlet resistance channel which is fluidically coupled to the outlet of the fluid chamber is used. The outlet resistance channel prevents emptying of the fluid chamber, i.e. removing the liquid from areas of the surface outside the recesses, until the arrangement of recesses has been completely passed over by a flow of the liquid, or until the fluid chamber has been completely filled. The outlet resistance channel limits a volumetric outflow of the liquid from the chamber through the outlet. By means of the outlet resistance channel, the liquid volume flows at a substantially slower rate out of the fluid chamber than when introduced into the fluid chamber. A flow resistance of the resistance channel at the outlet should be significantly higher than a flow resistance at the inlet (the flow resistance at the inlet can be defined, for example, by way of an inlet resistance channel or by way of flow-restricting ventilation of the fluid chamber, see the explanations above), so as to prevent that the fluid chamber is emptied directly by way of the resistance channel at the outlet due to the centrifugal force. A cross section and/or a length of the outlet resistance channel is designed in such a way, for example, that the outlet resistance channel prevents emptying of the fluid chamber until the arrangement of recesses has been completely passed over by a flow of the liquid, or the fluid chamber has been completely filled. Dimensioning of the outlet resistance channel and/or of the inlet channel can be determined, for example, based on a calculation of hydrodynamic resistances of the inlet channel and the outlet channel. Filling of all recesses of the arrangement can be very efficiently ensured by the outlet resistance channel. At the same time, a dead volume is minimized because the outlet resistance channel is designed with a small cross section in order to provide the needed flow resistance. This enables savings in terms of valuable specimens or costly reagents.

One embodiment relates to a fluidic module for generating spatially separated liquid partitions while using one of the methods described herein. The fluidic module comprises a fluid chamber, inlet structures and outlet structures. The fluid chamber comprises the surface in which the arrangement of recesses is formed. The inlet structures are designed, during rotation of the fluidic module, to introduce liquid into the fluid chamber by means of centrifugal force in order to transport the liquid from radially outside to radially inside across the arrangement of recesses. The outlet structures are designed, after a flow has passed over the surface in which the arrangement of recesses is formed, to remove the same liquid from areas of the surface outside the recesses in order to generate the spatially separated liquid partitions of the liquid in the recesses.

The outlet structures and/or inlet structures are designed in such a manner, for example, that, during the rotation of the fluidic module, more liquid is introduced into the fluid chamber by means of the centrifugal force than there is liquid removed from the fluid chamber during the introduction. This enables efficient filling of the fluid chamber from radially outside to radially inside. This can be implemented, for example, in that the outlet structures and inlet structures are designed in such a manner that a flow resistance at the outlet of the fluid chamber is greater than a flow resistance at the inlet of the fluid chamber. Alternatively, this can be implemented in that the outlet structures comprise a siphon which is fluidically coupled to an outlet of the fluid chamber and is designed to be filled, conjointly with the fluid chamber, from radially outside to radially inside, and the apex of said siphon is disposed radially further inside than a radially innermost point of the arrangement of recesses. Advantageously, the siphon comprises a cross section perpendicular to the filling direction, said cross section being smaller than a cross section of the fluid chamber perpendicular to the filling direction so as to minimize a dead volume. The filling direction runs from radially outside to radially inside, i.e. in the direction of a centre of rotation.

In embodiments, the fluid chamber forms a gap, for example a tight cavity or a narrow cavity, between the surface in which the arrangement of recesses is formed and a surface lying opposite this surface. The surface in which the arrangement of recesses is formed and the surface lying opposite this surface face the cavity of the fluid chamber, i.e. the gap, or delimit the gap, for example to two mutually opposite sides. A gap height of the gap is, for example, at most 10 times the depth of the recesses, and/or the gap height is at most 200 μm, advantageously at most 100 μm. The gap height corresponds, for example, to an extent of the gap perpendicular to the surface in which the arrangement of recesses is formed. The gap height corresponds, for example, to a spacing between the surface in which the arrangement of recesses is formed and the surface lying opposite this surface. The depth of the recesses corresponds, for example, to an extent of the recesses perpendicular to the surface in which the arrangement of recesses is formed. The inventors have recognized that, by filling a fluid chamber from radially outside to radially inside by means of rotating the fluidic module, centrifugal forces can be utilized for filling the fluid chamber in comparison to which a capillary force becomes negligible. Owing to this fact, controlled and efficient filling of the fluid chamber can be achieved even in fluid chambers with a small chamber height, i.e. with a small gap height. The special fluidic module enables a gap height which is at most 10 times the depth of the recesses and/or at most 200 μm, advantageously at most 100 μm, as a result of which a dead volume is minimized.

According to an embodiment, the gap height of the gap comprises a minimum height of 10 μm. This ensures, for example, that the centrifugal force exceeds the capillary forces by 5 to 10 times when typical rotational frequencies (e.g. at most 100 Hz) are applied. Furthermore, this minimum height enables controlled production of the fluid chamber, for example when a plastics material instead of glass or silicon is utilized for the production of the fluidic module. If the fluidic module comprises glass material or silicon material, a smaller minimum height could also be achieved under certain circumstances.

In embodiments, the inlet structures comprise an inlet chamber which is at least in part disposed radially further inwards than an innermost portion of the arrangement of recesses. Furthermore, the inlet structures comprise a fluid channel which connects the inlet chamber to the fluid chamber. As a result of this special arrangement of the inlet chamber, filling of the fluid chamber from radially outside to radially inside is made possible because, during the rotation of the fluidic module, a liquid which is disposed in the inlet chamber is transported radially outwards by way of the fluid channel into the fluid chamber to a radially outermost point of the fluid chamber and within the fluid chamber fills the fluid chamber from radially outside to radially inside.

For example, if an inlet of the fluid chamber to which the fluid channel is fluidically coupled is located at a radially innermost point of the fluid chamber, the entire liquid from the inlet chamber can be introduced into the fluid chamber from radially outside to radially inside. If the inlet is disposed radially further outside than the radially innermost point of the fluid chamber, or even at the radially outermost point of the fluid chamber, the fluid chamber is thus filled from radially outside to radially inside until a radial filling level within the fluid chamber corresponds to a radial filling level within the inlet structures, i.e. to the fluid channel. Owing to the fact that the inlet chamber is however disposed at least in part radially further inside than a radially innermost portion of the arrangement of recesses, it is ensured that the arrangement of recesses is completely passed over by a flow of the liquid, or the fluid chamber is filled up to a radially innermost point of the arrangement by means of the rotation. If the inlet is not disposed at the radially outermost point of the fluid chamber, the fluid chamber comprises a bypass in the lateral area of the chamber, with a lower flow resistance. This prevents that the liquid is first transported from radially inside to radially outside across the arrangement of recesses, because the liquid is transported from the inlet by way of the bypass, past the arrangement of recesses, direct to the radially outermost point of the fluid chamber, and from there fills the fluid chamber from radially outside to radially inside.

In embodiments, the inlet structures comprise an inlet resistance channel which is designed to limit the liquid flow into the fluid chamber. Alternatively, the fluid chamber comprises flow-restricted ventilation which is designed, when introducing the liquid into the fluid chamber, to generate a pneumatic counter pressure in the fluid chamber in order to limit the fluid flow into the fluid chamber. Alternatively, the inlet chamber comprises flow-restricted ventilation which is designed, when introducing the liquid into the fluid chamber, to generate a pneumatic vacuum in the inlet chamber in order to limit the liquid flow into the fluid chamber. It is made possible by the flow limitation that a liquid reaches the arrangement of recesses at the earliest when reaching a predetermined rotational frequency and thus controlled transport of the liquid across the arrangement from radially outside to radially inside is ensured. This is based on the knowledge that, at the beginning of the rotation of the fluidic module, for example when starting a centrifuge which comprises the fluidic module, the rotational frequency increases with a delay and a desired rotational frequency is not achieved instantaneously.

In embodiments, the outlet structures comprise a volume-controlled switch which enables emptying of the fluid chamber only once the arrangement has been completely passed over by a flow of the liquid. Alternatively, the outlet structures comprise an outlet resistance channel which prevents emptying of the fluid chamber until the arrangement has been completely passed over by a flow of the liquid. Filling all recesses of the arrangement can be very efficiently ensured as a result.

Embodiments relate to a device for performing one of the methods described herein. The device comprises one of the fluidic modules described herein and a drive installation for rotating the fluidic module.

### BRIEF DESCRIPTION OF THE DRAWINGS

In terms of the schematic figures illustrated, it is pointed out that the function blocks illustrated are understood to be elements or features of the device according to the invention as well as corresponding method steps of the method according to the invention, and corresponding method steps of the method according to the invention can also be derived therefrom. Embodiments of the present invention will be detailed subsequently referring to the appended drawings, in which:

FIG. 1 shows a schematic illustration of a method for generating spatially separated liquid partitions and of a fluidic module for use in the method;

FIG. 2 shows schematic illustrations of a fluid chamber and of embodiments of a surface of the fluid chamber;

FIGS. 3a-3b show schematic illustrations of recesses in a surface of a fluid chamber;

FIG. 4 shows schematic illustrations of a fluid chamber when filling the latter with a liquid;

FIGS. 5a) to 5e) show a schematic illustration of a method for generating spatially separated liquid partitions in a fluid chamber;

FIG. 6 shows a schematic illustration of a sequence of microfluidic filling and sealing of recesses in a fluidic module with a volume-controlled switch;

FIG. 7 shows a schematic illustration of a sequence of microfluidic filling and sealing of recesses in a fluidic module with an outlet resistance channel; and

FIGS. 8A and 8B show schematic illustrations of examples of fluid handling devices according to the invention.

### DETAILED DESCRIPTION OF THE INVENTION

Before embodiments of the present invention are explained in more detail hereunder by means of the drawings, it is pointed out that identical, functionally identical or functionally equivalent elements, objects and/or structures are provided with the same or similar reference signs in the different figures, so that the description of these elements illustrated in different embodiments is mutually interchangeable, or can be applied thereto. A repeated description of elements which are provided with the same or similar reference sign is typically omitted. In particular, identical or similar elements can in each case be provided with reference signs which comprise an identical number with a different or without a lower-case letter or with a different or without a suffix. In the description hereunder, many details are described in order to provide a more thorough explanation of examples of the disclosure. However, other examples can also be implemented without these specific details. Features of the different examples described can be combined with one another unless features of a corresponding combination are mutually exclusive or such a combination is expressly precluded.

Before examples of the present disclosure will be explained in more detail, definitions pertaining to some of the terms used herein are set forth.

The term liquid as used herein includes in particular also liquids which contain solids such as, for example, suspensions, biological specimens and reagents. For example, a mixture of substances, the reaction of which enables a pre-analytical or analytical function, for example the direct detection of nucleic acids by means of fluorescent reaction (digital PCR) is referred to as a reaction liquid. A substance or a mixture of substances, the properties of which enables the sealing of the recesses and thus prevents an interfacial area between the reaction liquid and air or other gases, or gas mixtures, is referred to as a sealing liquid.

A siphon or siphon channel herein is understood to mean a microfluidic channel or portion of a microfluidic channel in a fluidic module (of a centrifugally microfluidic cartridge), in which the inlet and the outlet of the channel (when used in a centrifugally microfluidic system, or a centrifugally microfluidic platform) comprise a greater spacing from the centre of rotation than an intermediate area of the channel. A siphon apex, or an apex of the siphon, is understood to mean the area of a siphon channel in a fluidic module with a minimum spacing from the centre of rotation. Because the apex of such a siphon is inverted in the centrifugal field in comparison to the arrangement of a typical siphon in the Earth's gravitational field, such a siphon in the centrifugal field could also be referred to as an inverted siphon.

A fluidic module herein is understood to mean a module, for example a cartridge, which comprises microfluidic structures which are configured to enable liquid handling as described herein. For example, a fluidic module is an inherently closed unit consisting of a fluidic structure and a capping of the latter. A centrifugal microfluidic fluidic module (cartridge) is understood to mean a corresponding module which can be subjected to rotation, for example in the form of a fluidic module, which can be inserted in a rotational solid, or of a rotational solid. In examples of the present invention, the fluidic module is a centrifugally microfluidic fluidic module.

A fluidic structure, or a microfluidic structure, comprises, for example, structures or cavities which are open on one side, for example for channels and chambers of a fluidic module.

A capping comprises, for example, a film or a plate which is adhesively bonded or welded to the fluidic structure.

When reference is made to a fluid channel herein, this means a structure, the longitudinal dimension of which from a fluid inlet to a fluid outlet is larger, for example more than 5 times or more than 10 times larger, than the dimension or dimensions which defines or define the flow cross section. Thus, a fluid channel comprises a flow resistance for a flow thereof passing through from the fluid inlet to the fluid outlet. A channel, or fluid channel, refers, for example, to a volume in a fluidic module which is delimited by a capping and at least one part, for example a channel part, of the fluidic structure. Typically, a fluid channel is smaller than 0.5 mm in terms of at least two dimensions and is significantly longer in the third dimension. For example, a fluid channel serves as a fluidic connection of fluid chambers, i.e. a fluid channel fluidically couples at least two fluid chambers to one another, for example.

In contrast, a fluid chamber herein is a chamber that comprises such dimensions that, when the chamber is passed through by a flow, a flow resistance which is negligible in comparison to connected channels and can be, for example, 1/100 or 1/1000 of the flow resistance of the channel structure that has the lowest flow resistance and is connected to the chamber arises. A chamber or a fluid chamber refers, for example, to a volume, which is delimited by the capping and at least one part, for example a chamber part, of the fluidic structure, in a fluidic module. Typically, a fluid chamber is larger than 0.5 mm in terms of at least two dimensions.

When the term recess is used herein, this is understood to mean, for example, a geometrically defined structure which is typically smaller than 0.5 mm in all three dimensions. A recess herein can also be referred to as well or partition. For example, a recess in a surface of a fluid chamber wall refers to a clearance in the surface or to a locally limited depression of the surface.

An arrangement of recesses herein is understood to mean, for example, a plurality of recesses which are disposed in a specific formation in a surface. The formation here can be designed to be of uniform or non-uniform shape or regular or irregular. The arrangement of recesses defines, for example, a locally limited area on a surface in which the recesses are disposed. In examples of the invention, this can be a planar arrangement of recesses which corresponds, for example, to an arrangement of the recesses in a plane. The arrangement of recesses can also be referred to as a pattern of recesses or as an array of recesses.

An array herein can be understood to mean a planar arrangement of recesses, typically in the form of a repetitive pattern, for example in the form of a matrix of lines and columns or a hexagonal arrangement of the recesses.

Examples of the invention can in particular be used in the field of centrifugal microfluidics which relates to the processing of liquids in the picolitre to millilitre range. Accordingly, the fluidic structures can comprise suitable dimensions in the micrometre range for the handling of corresponding liquid volumes.

Dividing a liquid, for example a reaction liquid, into sub-units (“partitions”) is referred to as partitioning herein. The purpose is to carry out digital reactions in that the partitions ideally contain a molecule or particle (digital “1”) or no molecule or particle (digital “0”). In practice, there can also be multiple occupancies of partitions by more than one molecule or particle, but this effect can be compensated for using statistical methods.

In order to suppress or at least drastically reduce an exchange between the partitions during a reaction, a sealing liquid fills the space between two or more partitions, for example. A sealing liquid is understood to mean, for example, a liquid which cannot be homogeneously mixed with a liquid divided into the partitions, i.e. with the liquid partitions.

When the term radial is used herein, this means in each case radial in terms of the centre of rotation about which the fluidic module, or the rotational solid is rotatable. Thus, in the centrifugal field, a radial direction away from the centre of rotation is radially descending, and a radial direction towards the centre of rotation is radially ascending. Thus, a fluid channel, the beginning of which is closer to the centre of rotation than the end thereof, is radially descending, while a fluid channel, the beginning of which is further away from the centre of rotation than the end thereof, is radially ascending. Thus, a channel which comprises a radially ascending portion comprises directional components which radially ascend or run radially inwards. It is obvious that such a channel does not have to run exactly along a radial line but can run at an angle relative to the radial line or in a curved manner. Thus, radially further outwards means further away from the centre of rotation, and radially further inwards means closer to the centre of rotation.

A rotational frequency, which is herein also referred to as a rotating speed, is understood to mean the number of rotations N per unit of time t in the unit 1/second (s⁻¹) or 1/minute (min⁻¹) or Hz.

A dead volume is understood to mean, for example, a part of the liquid (for example of a reaction liquid) introduced into the system, i.e. a part of the liquid from which spatially separated liquid partitions are to be generated, which does not land in the partitions and is thus not analysed.

Examples of the present disclosure achieve devices and methods for partitioning molecules or particles in arrays, i.e. liquids which comprise molecules and/or particles. Examples are directed towards devices and methods for generating spatially separated liquid partitions which are geometrically defined in terms of location and size. The object of the partitioning is that of implementing digital assays, for example digital PCR or digital immunoassays; however, the examples disclosed herein are not limited thereto. The core of the invention is a device with defined recesses (partitions) in a surface, which are filled with liquids by means of centrifugation. In the process, the recesses are filled by being passed over by a flow with a first liquid, for example an aqueous reaction mix. Subsequently, excess liquid is removed by being ejected from the recesses. In a further optional centrifugation step, the open side of the recesses is sealed by a second liquid, for example oil.

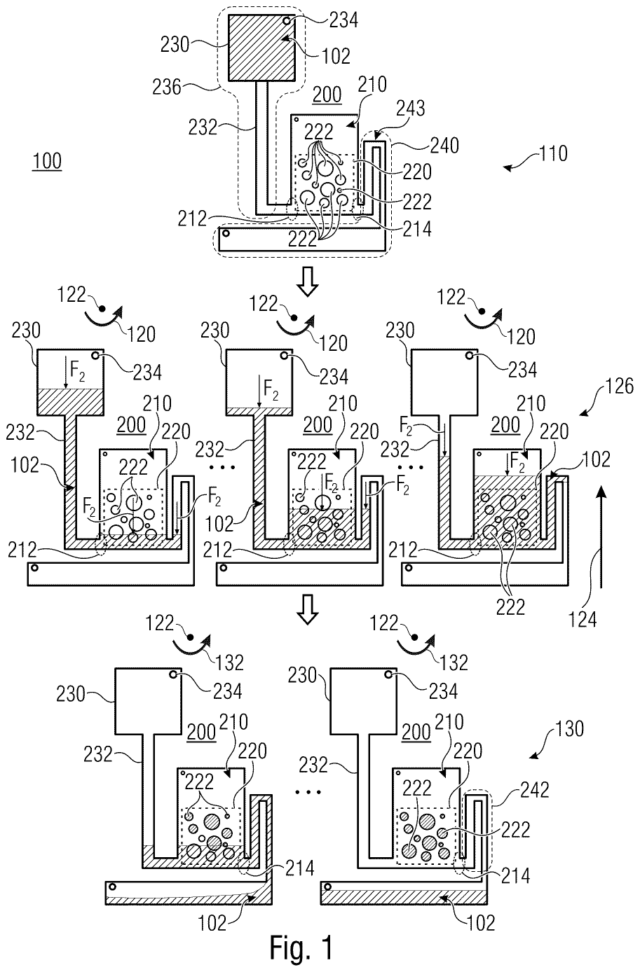

An embodiment of a method 100 according to the invention is illustrated in FIG. 1. The method is used for partitioning a liquid 102.

In the method 100, a fluidic module 200 is provided 110. FIG. 1 shows a top view of the schematic fluidic module 200. The fluidic module 200 comprises a fluid chamber 210. The fluid chamber 210 comprises a surface which comprises an arrangement 220 of recesses 222. The method 100 generates spatially separated liquid partitions in the arrangement 220 of recesses 222 formed in the surface.

The surface which comprises the arrangement 220 of recesses 222 can be a planar surface or an inclined or curved surface. An inclined or curved surface has the advantage that gas bubbles which are potentially created in the fluid chamber 210 for example when introducing 126 a liquid 102 or when heating a liquid 102 can be transported away in a targeted manner.

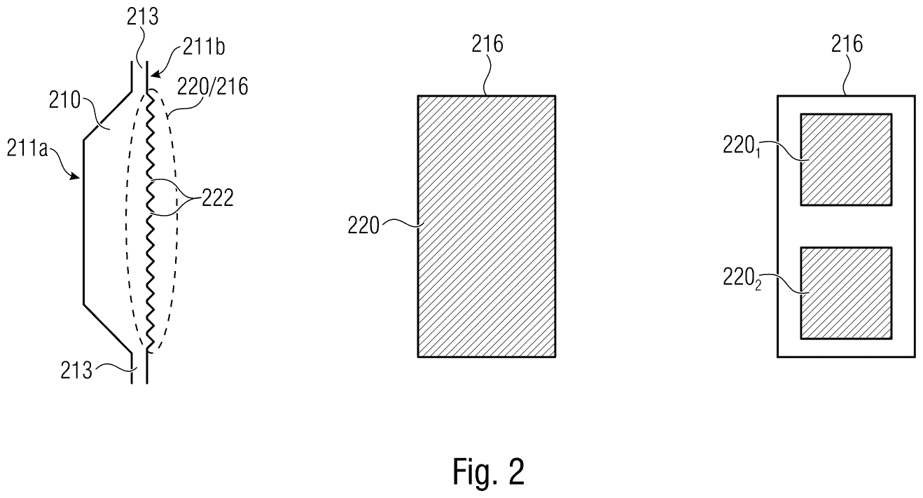

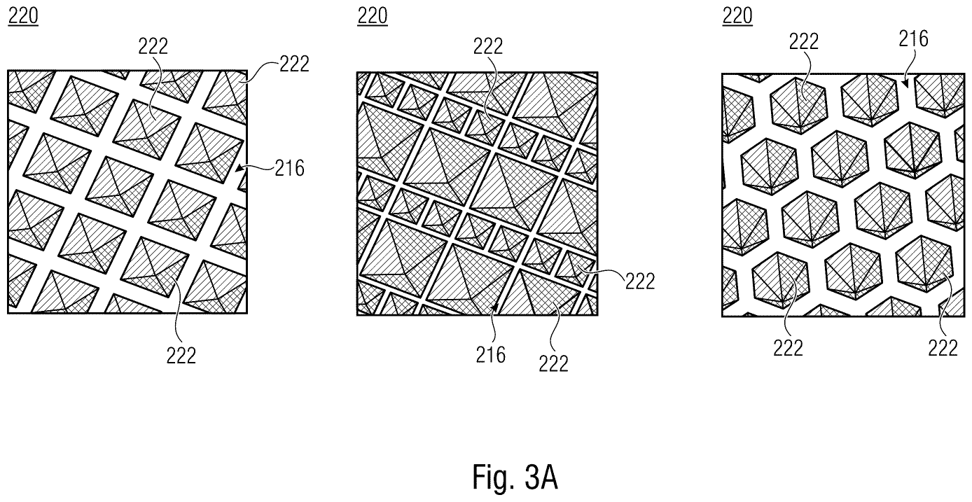

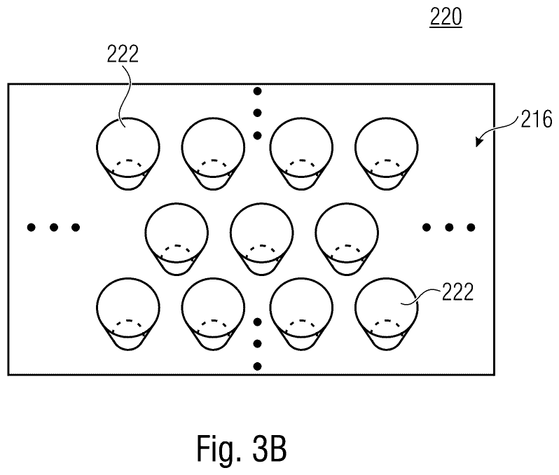

The arrangement 220 of recesses 222, schematically shown in FIG. 1, comprises recesses 222 with a round cross section. The recesses 222 correspond, for example, to cylindrical and/or semi-spherical and/or spherical-segment-shaped and/or conical and/or frustoconical recesses. Alternatively or additionally, the arrangement 220 can comprise recesses 222 having a different geometrically defined structure, see FIG. 3 and the associated explanations, for example. Furthermore, the recesses 222 illustrated in FIG. 1 are in a non-uniform arrangement. Alternatively or additionally, the surface of the fluid chamber 210 can also comprise a uniform arrangement of recesses, see FIGS. 2 to 7 and the associated explanations, for example. A further feature of the recesses 222 illustrated in FIG. 1 is the different size thereof, i.e. the different volume or filling capacity thereof. Alternatively, the arrangement 220 can also comprise only recesses 222 having identical size, see FIGS. 2 to 7 and the associated explanations, for example. The arrangement 220 of recesses 222 illustrated in FIG. 1 covers at least part of the surface of the fluid chamber 210 on which the arrangement 220 is disposed. Alternatively, the recesses 222 can also be disposed on the complete surface which comprises the arrangement 220.

By rotating 120 the fluidic module 200 about a centre of rotation 122, a centrifugal force Fz is exerted on the liquid 102, through which the liquid 102 is introduced 126 into the fluid chamber 210, and through which at least part of the liquid 102 is transported from radially outside to radially inside, i.e. in a radially ascending direction 124, across the arrangement 220 of recesses 222. The liquid 212 is introduced 126 into the fluid chamber 210 by way of an inlet 212 of the latter.

The centre of rotation 122 is only schematically plotted in FIG. 1 and can alternatively also be located further away from the fluidic module 200, as illustrated.

Furthermore, rotation 120 counterclockwise has been illustrated by way of example in FIG. 1. Alternatively however, it is also possible that the fluidic module 200 is rotated 120 clockwise.

By means of rotating 120 the fluidic module 200, the liquid 102 is introduced 126, for example from a radially further inwards area of the fluidic module 200, into the fluid chamber 210. Radially further inwards herein is understood to mean relative to the radially innermost position of the arrangement 220. The radially further inwards area is, for example, disposed at least partially radially further inwards than the arrangement 220 of recesses 222. The centrifugal force Fz acting on the liquid 102 thus transports the liquid 102 from the radially further inwards area of the fluidic module 200 from radially inside to radially outside, i.e. in a radially descending direction, into the fluid chamber 210. However, the fluid chamber 210 per se is filled from radially outside to radially inside. This is based on the fact that the centrifugal force Fz which is exerted on the liquid 102 first transports the liquid 102 within the fluid chamber 210 to the radially outermost point of the latter and a radial filling level of the fluid chamber 210 is then increased radially towards the inside as the liquid 102 which is introduced 126 into the fluid chamber 210 increases.

The radially further inwards area of the fluidic module 200 is fluidically coupled by way of a fluid channel, for example an inlet channel 232, to the inlet 212 of the fluid chamber 210. The radially further inwards area can comprise a liquid inlet 234 and/or more further fluid chambers and/or one or more further fluid channels. In FIG. 1, the radially further inwards area by way of example comprises an inlet chamber 230, or reservoir chamber. In other words, the inlet chamber 230 is at least in part disposed radially further inwards than a radially innermost portion of the arrangement 220 of recesses 222. The inlet chamber 230 optionally comprises a liquid inlet 234 by way of which the liquid 102 can be introduced into the inlet chamber 230. The inlet chamber 230 is coupled/connected to the inlet 212 of the fluid chamber 210 by way of the inlet channel 232, i.e. a fluid channel. In FIG. 1, the fluidic module 200 thus comprises by way of example an inlet chamber 230 in which the liquid 102 is provided.

The fluidic module 200 comprises, for example, inlet structures 236 which are fluidically coupled to the inlet 212 of the fluid chamber 210. For example, the inlet structures 236 comprise the radially further inwards area of the fluidic module 200 and the fluid channel by way of which the radially further inwards area is fluidically coupled to the inlet 212 of the fluid chamber 210. The inlet structures 236 in FIG. 1 by way of example comprise the inlet chamber 230 and the inlet channel 232.

In FIG. 1, the inlet 212 of the fluid chamber 210 is by way of example disposed at a radially outermost point of the fluid chamber 210. It is thus made possible that the arrangement 220 of recesses 222 is passed over by a flow of the liquid 102 only from radially outside to radially inside when the liquid 102 is introduced 126. In contrast, if the inlet 212 is disposed radially further inwards than the radially outermost point of the fluid chamber 210, the arrangement 220 of recesses 222 could at least in part be passed over by a flow of the liquid 102 from radially inside to radially outside, because the centrifugal force Fz acting on the liquid 102 during the rotation 120 first transports the liquid 102 from the inlet 212 to radially outside to the radially outermost point of the fluid chamber 210. Thus, the inlet 212 on the radially outermost point of the fluid chamber 210 improves controlled filling of the fluid chamber 210.

Alternatively, the inlet 212 could also be disposed radially further inwards than the radially outermost point of the fluid chamber 210. In such a case however, it would be advantageous when the fluid chamber 210, laterally of the arrangement 220, i.e. past the arrangement, furthermore comprises a bypass with low flow resistance in order to avoid that the arrangement 220 is passed over by a flow from radially inside to radially outside.

If the inlet 212 of the fluid chamber 210 is located at a radially innermost point of the fluid chamber 210, the complete liquid 102, for example from the inlet chamber 230, can be introduced into the fluid chamber 210. In contrast, if the inlet 212 is disposed radially further outside than the radially innermost point of the fluid chamber 210, or even at the radially outermost point of the fluid chamber 210, the fluid chamber 210 is thus filled from radially outside to radially inside until a radial filling level within the fluid chamber 210 corresponds to a radial filling level within the inlet structures, i.e. to the inlet channel 232. In this context, the liquid volume of the liquid 102 and the chamber geometry of the fluid chamber 210 should be designed in such a manner that a radial filling level achieved when introducing 126, i.e. filling, the fluid chamber 210 is disposed radially further inwards than a radially innermost point of the arrangement 220 of recesses 222, so as to guarantee complete filling of all recesses 222.

The method 100 furthermore comprises removing 130 the liquid 102 from areas of the surface outside the recesses 222, i.e. excess liquid 102, in order to generate the spatially separated liquid partitions of the liquid 102 in the recesses 222. This means that the liquid 102 that is not disposed in the recesses 222 is removed 130. It is schematically shown at the bottom right in FIG. 1 that the fluid chamber 210 after the removal 130 of excess liquid 102 only comprises the liquid 102 in the recesses 222. The liquid 102 is removed 130 from the fluid chamber 210 through an outlet 214 of the latter.

Removing 130 the excess liquid 102 from the fluid chamber 210 can take place, for example, by rotating 132 the fluidic module 200 about the centre of rotation 122. As a result, the excess liquid 102 can be ejected from the fluid chamber 210. The rotation 120 for introducing 126 the liquid 102 into the fluid chamber 210 and the rotation 132 for removing 130 the excess liquid 102 from the fluid chamber 210 do not differ, for example. Alternatively, the rotation 120 for introducing 126 the liquid 102 and the rotation 132 for removing 130 the excess liquid 102 could differ in terms of a rotating speed, or rotational frequency, and/or rotating direction by way of which the fluidic module 200 is in each case impinged. The excess liquid 102 could be removed 130 by rotation 132 at a higher rotating speed than during the rotation 120 when introducing 126 the liquid 102, for example. Owing to the fact that the excess liquid is removed by means of rotation of the fluidic module 200, for example at a constant rotating speed or even increased rotating speed, a reflux of the liquid 102 into the inlet structures 236 is avoided. For example, the rotation 120 for introducing 126 and the rotation 132 for removing 130 are performed in the same rotating direction, for example clockwise or counterclockwise.

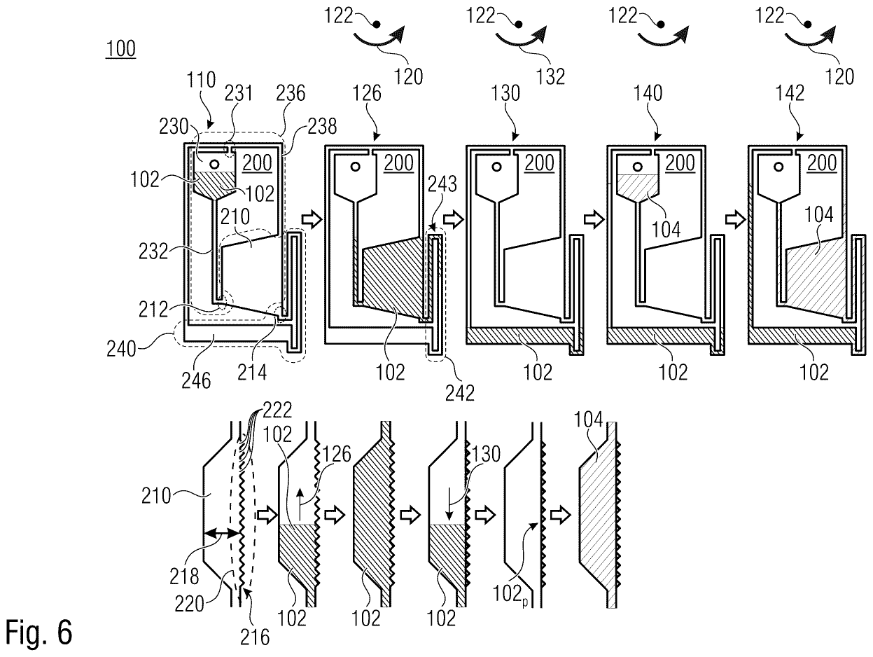

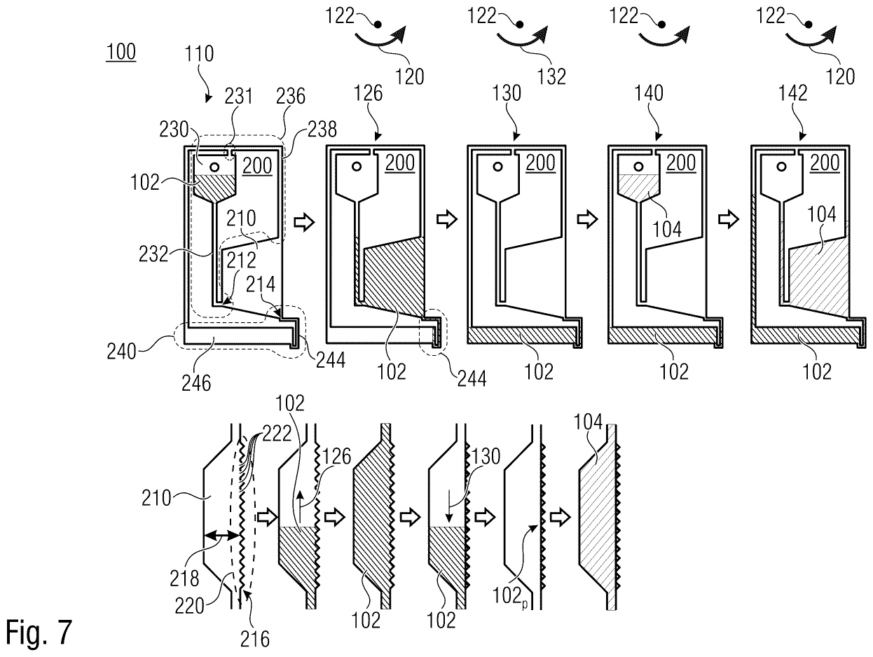

The fluidic module 200 comprises, for example, outlet structures 240 which are fluidically coupled to the outlet 214 of the fluid chamber 210. The outlet structures 240 are designed to remove 130 through the latter the liquid 102 from the areas of the surface outside the recesses 222 after a flow has passed across the surface in which the arrangement 220 of recesses 222 is formed. The outlet structures 240 are designed to prevent premature emptying of the fluid chamber 210, i.e. before all recesses 222 of the arrangement 220 have been able to be filled with the liquid 102. This special design of the outlet structures 240 furthermore facilitates the filling of the fluid chamber from radially outside to radially inside, since the outlet structures 240 are designed, while introducing 126 the liquid into the fluid chamber 210, to remove 130 less liquid 102 from the fluid chamber 210 than is introduced 126 per unit of time into the fluid chamber 210. This can be implemented, for example, in that the outlet structures 240 comprise a volume-controlled switch 242, a flow-restricting unit or a pressure-controlled switch, which is designed to prevent premature emptying of the fluid chamber 210. In FIG. 1, for example, a volume-controlled switch 242 in the form of an inverted siphon is implemented, the apex 243 of which is disposed radially further inwards than a radially innermost point of the arrangement 220 of recesses 222. The volume-controlled switch 242 is explained in detail in the context of FIG. 6. Alternatively, the outlet structures 240 could comprise, for example, a flow-restricting unit, such as, for example, an outlet resistance channel, which is designed to limit a liquid flow out of the fluid chamber 210. A flow-restricting unit is explained in detail in the context of FIG. 7. Alternatively, the outlet structures 240 could comprise, for example, a pressure-controlled switch, such as, for example, a pressure-dependent valve, which is designed to remove 130 the liquid 102 from the fluid chamber 210 only once a predetermined pressure, which is exerted on said valve by the liquid 102, is exceeded.

When the excess liquid 102 is removed 130, or sheared, the liquid 102 remains in the recesses 222 and is removed 130 only from the surrounding areas. The liquid 102 remains in the recesses 222, since the centrifugal force Fz acting on the small liquid volumes disposed in the recesses 222 is less than the capillary forces acting on said liquid volumes, i.e. for each of the recesses 222, a capillary force caused thereby keeps the respective liquid volume within the respective recess 222.

The invention relates to a device, see the fluidic module 200, and a method 100 for generating spatially separated partitions which are fixedly defined geometrically in terms of location and size and which:
can be integrated into a polymer chip in a cost-effective manner
do not require a channel network for filling, i.e. when introducing 126 the liquid 102 into the fluid chamber 210, all recesses 222 are passed over by a flow, and it is unnecessary to individually fill each recess 222 by means of a channel
do not require hydrophilization or hydrophobizaton for filling.
Drastically reduce the dead volume in comparison to conventional technology.

FIG. 2 schematically shows a concept for a fluid chamber 210. One of the fluidic modules 200 described herein can comprise a fluid chamber 210 which comprises features as explained in the context of FIG. 2.

FIG. 2 shows on the left a cross section, or a lateral view, of the fluid chamber 210 and in the centre a top view of the fluid chamber 210, or a detailed view of the surface 216 of the fluid chamber 210, which comprises the arrangement 220 of recesses. Shown on the right is an alternative for the design of the surface 216.

It can be seen on the extreme left that the fluid chamber 210 can comprise fluidic connectors 213. Furthermore, the fluid chamber 210 comprises a surface 216 in which the arrangement 220 of recesses 222 is formed. FIG. 2, on the extreme left in combination with the detailed view in the centre, shows an embodiment in which the recesses 222 are completely distributed in the surface 216, i.e. the arrangement 220 of recesses 222 completely occupies the surface 216. Alternatively, as shown by way of example on the extreme right, the surface 216 of the fluid chamber 210 could comprise two or more arrangements, see 2201 and 2202, of recesses 222. FIG. 2 shows in the centre and on the right exemplary designs of the arrangement 220 of recesses 222 as local delimited areas of the recesses (see on the right) and recesses 222, which completely cover a surface 216 of a fluid chamber 210, as a global arrangement (see the centre). In other words, the fluid chamber 210 can comprise a global arrangement 220 of recesses as illustrated in the centre, or comprise local arrangements 2201 and 2202 of recesses as can be seen on the right.

According to an embodiment, a fluidic module 200 described herein can consist of at least two parts. A first part, for example a fluidic part 211a, comprises for example a fluidic structure of fluid chambers and/or fluid channels for implementing microfluidic functions. A second part, for example a cover part 211b, is designed to implement a capping of the fluidic structure. At least one of the two, or both, parts comprise planarly disposed recesses 222 in an area of the surface 216, see 220, or in more areas of the surface 216, see the arrangements 2201 and 2202. The recesses 222 on the left in FIG. 2 are plotted by way of example in the cover part 211b but can likewise be integrated in the fluidic part 211a or in both parts.

FIGS. 3a and 3b show exemplary geometries and fragments of arrangements 220 of recesses 222 in top view. The three arrangements 220 illustrated in FIG. 3a and the arrangement 220 illustrated in FIG. 3b represent arrays of recesses 222, i.e. the recesses 222 are disposed in lines and rows in the surface 216 of a fluid chamber.

An arrangement 220 of recesses can comprise, for example, only recesses of identical size, see on the right and the left in FIG. 3a and FIG. 3b, or recesses of different sizes, see in the centre in FIG. 3a. The central arrangement 220 of recesses 222 in FIG. 3a comprises by way of example recesses 222 with two different sizes. Utilizing arrangements 220 with recesses 222 of different sizes enables, for example, an efficient analysis of different analyte concentrations in the liquid (so-called dynamic range). The combination of more than two different sizes of recesses can be expedient for specific applications. Likewise, the combination of different geometries can be advantageous, for example when a different geometry proves advantageous for filling small recesses than for filling large recesses.

The recesses 222 of the arrangements 220 illustrated in FIG. 3a are pyramidal, i.e. the recesses 222 form pyramidal recesses in the surface 216. Illustrated by way of example on the left and in the centre are quadrilateral pyramidal recesses 222, and illustrated by way of example on the right are hexagonal pyramidal recesses 222. Apart from the geometries illustrated, other geometries for the recesses 222, for example frustums of pyramids, cylinders, hemispheres, spherical segments, semi-ellipsoids, ellipsoid segments, cones, frustums of cones, cubes or prisms, are also able to be implemented.

FIG. 3b shows by way of example an embodiment of a surface 216 with an arrangement 220 of recesses 222 in the form of a frustrum of a cone.

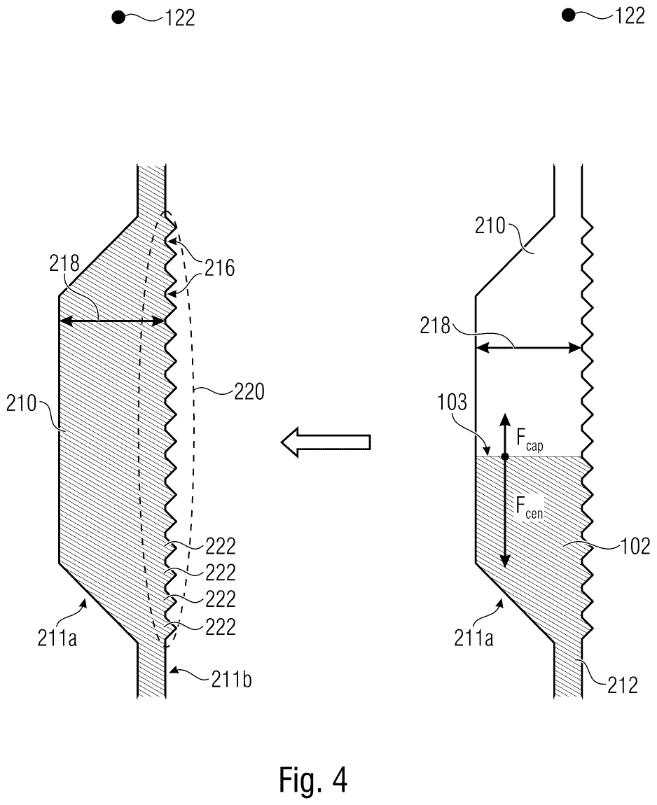

As is highlighted in FIG. 4, the core of the invention lies in minimizing the dead volume in the device, i.e. in the fluidic module 200 described herein, by way of an ideally small gap 218, or an ideally small chamber height between a surface 216 in which the arrangement 220 of recesses 222 is disposed and a surface lying opposite this surface 216. The gap is formed, for example, between the fluidic part 211a and the cover part 211b. The fluid chamber 210 of a fluidic module 200 described herein comprises, for example, a gap 218 as described in the context of FIG. 4. In FIG. 4, a completely filled fluid chamber 210 is schematically illustrated on the left, and the fluid chamber 210 during a filling procedure is schematically illustrated on the right.

In a completely filled fluid chamber 210, the part of the liquid 102 that is disposed in the recesses 222 of the fluid chamber 210 defines an analysis volume V_{analysis}, and the remaining part of the liquid 102 defines the dead volume V_{dead}. The chamber height, or the gap 218, defines significantly the ratio of dead volume to analysis volume. A cross section of inlet channel and outlet channel, or of inverted siphon, can likewise influence the dead volume and thus the ratio of dead volume to analysis volume. The smaller the chamber height, the smaller the dead volume. In the methods 100 and fluidic modules 200 described herein, a gap height of the gap 218 can be smaller than or equal to 200 μm, advantageously smaller than or equal to 100 μm. It is made possible that the gap height is at most 10 times a depth of the recesses 222.

The dead volume can be minimized in that filling of the recesses 222 takes place in a defined way from radially outside to radially inside, as illustrated on the right in FIG. 4, by means of high centrifugal force (F_{cen}). The centre of rotation 122 is schematically plotted as a reference for the direction of filling. By using correspondingly high centrifugal forces (F_{cen}), capillary forces (F_{cap}) which can otherwise interfere with the filling procedure, for example by including air bubbles in the area of the recesses 222, become negligibly small. The capillary forces increase as the chamber height decreases and may lead to uncontrolled filling of the partitions. As a result of high centrifugal forces, the capillary forces, in relative terms, become negligibly small and defined filling of the chamber from radially outside to radially inside takes place. Radial filling levels of the fluid chamber 210 are designed by a liquid volume of the liquid 102 to be introduced and a chamber geometry of the fluid chamber 210 in such a manner, and the rotation 120 of the fluidic module 200 takes place at such a rotating speed, that the centrifugal force acting on the liquid volume, or on the first liquid 102, is greater than the capillary force acting on the liquid 102 in the gap 218. As opposed to pressure-driven systems (vacuum and/or overpressure) as usual in conventional technology, the artificial field of gravity achieved by centrifugation is exploited here, as a result of which capillary forces become negligibly small. In the invention described here, there is thus a defined liquid front 103 created along the same hydrostatic pressure (i.e. along the same radius in the centrifugal-microfluidic system) that fills the array chamber, i.e. the fluid chamber 210, from radially outside to radially inside. This permits a very much smaller gap 218 than in conventional technology to be implemented and thus dead volumes to be minimized. While the chamber height in conventional technology is 500 μm [Kan_2012], the invention described here permits a chamber height of less than 100 μm. Depending on the embodiment of the recesses 222, the dead volume can thus be reduced from several 100 times the volume of the introduction volume to at most 1 to 100 times. Depending on the embodiment, a factor smaller than 1:1 between the dead volume and the analysis volume could be achieved.

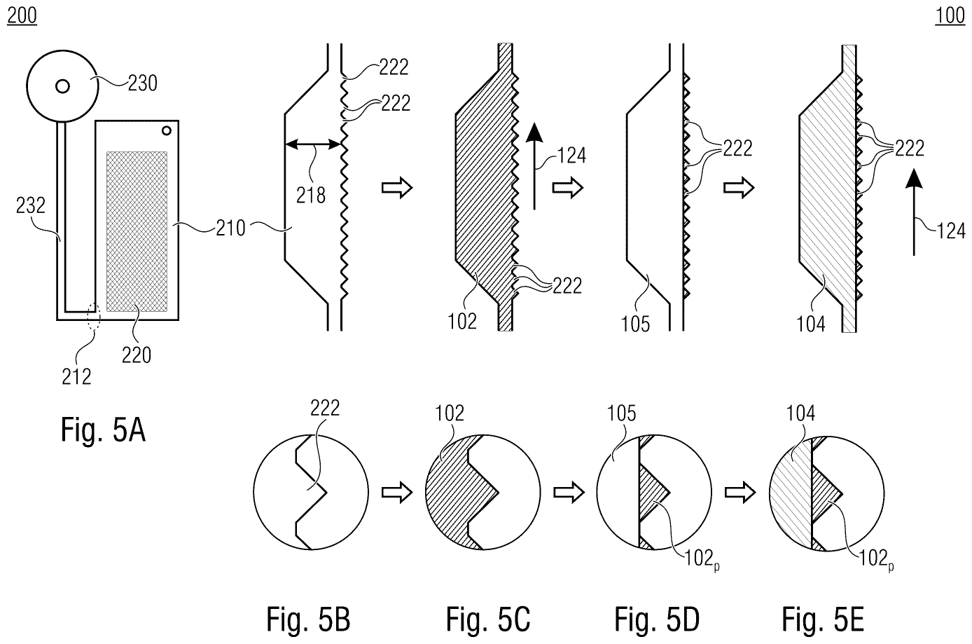

FIG. 5 shows by way of example a method 100 for partitioning a liquid which comprises, for example, molecules or particles in planar arrangements 220 of recesses 22 in four steps. Here, an enlargement of a recess 222 of a fluid chamber 210, or of an array chamber, is in each case illustrated below each step. Methods 100 described herein for generating spatially separated liquid partitions can comprise features as described in the context of FIG. 5.

Shown schematically in FIG. 5a is a fluidic module 200 for use in the method 100. The fluidic module 200 comprises by way of example an inlet chamber 230, an inlet resistance channel 232 and a fluid chamber 210 with a surface which comprises the arrangement 220 of recesses 222. FIGS. 5b to 5e show lateral views of the fluid chamber 210 conjointly with in each case an enlargement of a recess 222. FIG. 5b shows a lateral view of the fluid chamber 210 before filling with a first liquid 102, FIG. 5c shows a lateral view of the fluid chamber 210 after filling the recesses 222 with the first liquid 102, FIG. 5d shows a lateral view of the fluid chamber 210 after ejecting excess liquid 102 by centrifugation, and FIG. 5e shows a lateral view of the fluid chamber 210 after sealing the recesses 222 filled with the first liquid 102 by means of a second liquid 104.

The core of the method 100 lies in precise and reproducible filling of the recesses 222 with a first liquid 102 and in separating the liquid partitions 102ₚ in the recesses 222 from one another by a seal in form of a second liquid 104. The method 100 comprises one or more of the following individual steps:
Advantageously, the condition F_{Zen}>>F_{Kap} should be achieved by centrifuging or rotating the fluidic module 200. It is particularly advantageous herein when these conditions are achieved before a first liquid 102 reaches the recesses 222, so that the capillary forces in the area of the recesses 222, caused by the dead volume-minimizing gap 218, are significantly exceeded (see FIG. 5b). In other words, a centrifugal pressure is built up in the first liquid 102 before the latter reaches the fluid chamber 210 with the recesses 222. This can be achieved, on the one hand, by very rapidly starting up a centrifuge which comprises the fluidic module 200 or by a delaying fluidic element, or a flow-limiting element, for example a resistance channel 232 (see FIG. 5a), a pneumatic counter pressure in the fluid chamber, a pneumatic vacuum in the inlet chamber or a volume-based siphon as a switch, which lies ahead of the fluid chamber 210.
The filling of the recesses 222 takes place by passing a flow of the first liquid 102, for example an aqueous reaction mix, see FIG. 5c), over said recesses from radially outside to radially inside, i.e. in a radially ascending direction 124. In the process, the channel, i.e. the inlet resistance channel 232, between the inlet chamber 230 and the fluid chamber 210, can be connected either to the radially outer end of the fluid chamber 210, as shown in FIG. 5a, or else be connected to the fluid chamber 210 laterally, i.e. radially further inside than the radially outermost point of the fluid chamber 210, or at the radially innermost point, as long as it is ensured by the geometry of the fluid chamber 210 that the latter is filled radially from outside to radially inside (for example by way of a bypass in the lateral region of the fluid chamber 210, with a lower flow resistance, if the inlet 212 of the fluid chamber 210 is not located at the radially outermost point of the fluid chamber 210).
In a further step, potentially excess liquid is removed for example by being ejected from the recesses 222. This step is likewise achieved by the centrifugation of the fluidic module 200 and ensures precise defined liquid volumes, i.e. liquid partitions 102ₚ, in the recesses 222, see FIG. 5d). For example, capillary forces within the recesses 222 are greater than a centrifugal force acting on the liquid 102 during the ejection, as a result of which the liquid 102 is removed only from areas outside the recesses. Thus, after the ejection, the fluid chamber 210 comprises liquid partitions 102ₚ within the recesses 222, and the remainder of the fluid chamber 210 is filled, for example, with a gas 105, such as, for example, air.
In a further step, for example, an open side of the recesses 222 is sealed by a second liquid 104, for example oil. In the process, the second liquid 104 may not mix homogeneously with the first liquid 102 (FIG. 5e). The second liquid 104, like the first liquid 104, is introduced into the fluid chamber 210 in a radially ascending direction 124, for example.

FIGS. 6 and 7 show embodiments of a method 100 for generating spatially separated liquid partitions 102ₚ. Shown at the top are in each case top views of a fluidic module 200 when used in the respective method 100, and shown at the bottom are in each case lateral views of a fluid chamber 210 of the fluidic module 200 when used in the respective method 100, or cross sections of an exemplary fluid chamber 210 with recesses 222. FIGS. 6 and 7 show an exemplary sequence of the microfluidic filling and sealing of recesses 222. In the process, for example, a first liquid 102 is used for filling the recesses 222, and a second liquid 104 is used for sealing the recesses 222.

FIGS. 6 and 7 show by way of example a fluidic module 200 which comprises a fluid chamber 210, inlet structures 236 and outlet structures 240. As can be seen in each case in the detailed view at the bottom in the figures, the fluid chamber 210 comprises a surface 216 in which a plurality of recesses 222 is disposed. The arrangement of the recesses 222 is denoted by the reference sign 220.

The method 100 comprises providing 110 the fluidic module 200. For example, the fluidic module 200 is provided 110 conjointly with a first liquid 102. The inlet structures 236 comprise, for example, an inlet chamber 230 and an inlet channel 232. The inlet chamber 230 is fluidically coupled or connected to an inlet 212 of the fluid chamber 210 by way of the inlet channel 232. The first liquid 102 is provided in the inlet chamber 230, for example.

During the method 100, the fluidic module 200 is at least temporarily rotated about a centre of rotation 122 in order to introduce 126 one or more liquids into the fluid chamber 210 by way of the inlet structures 236 and optionally in order to remove 130 said liquid from the fluid chamber 210 again by way of the outlet structures 240. The method 100 comprises, for example, rotating 120 the fluidic module 200 for introducing 126 the first liquid 102 into the fluid chamber 210.

The fluid chamber 210 comprises, for example at opposite radially outer ends or corners, an inlet 212 and an outlet 214. Thus, the first liquid 102 can be introduced 126 into the fluid chamber 210 from radially outside as well as be removed 130 from the latter again radially outwards. For the complete removal of the first liquid 102 from the fluid chamber 210, it can be advantageous when the outlet 214 is connected to the radially outermost point of the fluid chamber 210, for example by way of a radial descent of the lower chamber side of the fluid chamber 210, i.e. by way of a radial descent of the surface 216 in which the recesses 222 are disposed. The positioning of the inlet 212 as well as of the outlet 214 radially on the outside has the advantage that a liquid can be introduced 126 in a controlled manner into the fluid chamber 210 and can likewise be removed 130 again from the latter in a controlled manner, and no liquid flows back again into the inlet chamber 230 during the removal 130 from the fluid chamber 210. Since the outlet 214 is disposed radially outside, the first liquid can be ejected from the fluid chamber 210 by rotating 132 the fluidic module 200. The rotation 132 for removing 130 the first liquid 102 can take place at the same rotational frequency as during the rotation 120 for introducing 126 the first liquid 102, or else at a lower or higher rotational frequency. When removing 130 the first liquid 102, the first liquid 102 is removed from areas of the surface 216 outside the recesses 222. A removal of this type can also be referred to as emptying the fluid chamber 210 because only the liquid partitions 102ₚ remain in the recesses 222 in the fluid chamber.

Since the inlet 212 as well as the outlet 214 are disposed radially outside, the outlet structures 240 are designed to suppress, for example, a direct exit of the introduced liquid from the fluid chamber 210. The outlet structures 240 are designed, when introducing 126 the first liquid 102, to allow less of the first liquid 102 to exit the fluid chamber 210 than is introduced into the latter. Thus, the outlet structures 240 make it possible that a flow of the first liquid 102 completely passes over the arrangement 220 of recesses 222 within the fluid chamber 210 from radially outside to radially inside. In FIG. 6, this is implemented in that the outlet structures 240 comprise a siphon 242, and in FIG. 7 this is implemented in that the outlet structures 240 comprise an outlet resistance channel 244. The siphon 242, or alternatively the outlet resistance channel 244, is fluidically coupled to the outlet 214 of the fluid chamber 210.

The siphon 242 illustrated in FIG. 6 can be considered to be a volume-controlled switch, because an apex 243 of the siphon 242 is disposed radially further inside than a radially innermost point of the arrangement 220 of recesses 222. As a result, when introducing 126 the first liquid 102, the fluid chamber 210 can be filled up to a maximum radial filling level which is radially level with the apex 243 of the siphon 242. The maximum radial filling level cannot be exceeded, because additionally introduced liquid would lead to the apex 243 of the siphon 244 being exceeded and thus the liquid is removed from the fluid chamber 210 by way of the siphon 242. In order to implement a complete flow over all recesses 222, the siphon 242 should be designed in such a manner that the maximum radial filling level is disposed radially further inside than a position of a radially innermost recess 222 of the arrangement 220 of recesses 222. For example, the siphon 242 is designed to enable the removal 130 of the first liquid 102 from areas of the surface 216 outside the recesses 222 only once the arrangement 220 of recesses 222 has been completely passed over by a flow of the first liquid 102.

The outlet resistance channel 244 illustrated in FIG. 7 is designed to limit an outflow of the first liquid 102 from the fluid chamber 210. For example, the outlet resistance channel has a smaller diameter than the inlet channel 232. Owing to this fact, more of the first liquid 102 can be introduced into the fluid chamber 210 by way of the inlet channel 232 than is simultaneously removed from said fluid chamber again by way of the outlet resistance channel 244. For example, the cross section of the outlet resistance channel 244 is sized in such a way that, when introducing 126 the first liquid 102, the fluid chamber 210 is filled until at least the complete arrangement 220 of recesses 222 has been passed over by a flow of the first liquid 102, i.e. until a radial filling level of the fluid chamber 210 is disposed radially further inside than a radially innermost recess 222 of the arrangement 220 of recesses 222. For example, the outlet resistance channel 244 is designed to enable the removal 130 of the first liquid 102 from areas of the surface 216 outside the recesses 222 only once the arrangement 220 of recesses 222 has been completely passed over by a flow of the first liquid 102.

Since the inlet 212 as well as the outlet 214 are disposed radially outside and an introduction of the first liquid 102 from radially outside to radially inside is needed for controlled filling of the fluid chamber 210, it is furthermore advantageous when the inlet structures 136 comprise ventilation 238 for the fluid chamber 210. For example, the fluid chamber 210 has an opening by way of which the fluid chamber 210 is connected to the ventilation 238. For example, the opening is disposed at a radially innermost point of the fluid chamber 210, or radially further inside than a radially innermost point of the arrangement 220 of recesses 222.

Both efficiency and control when introducing 126 the first liquid 102 into the fluid chamber 210 can be increased when the inlet structures 236 are designed to delay an entry of the first liquid 102 into the fluid chamber 210, or to delay the first liquid 102 reaching the arrangement 220 of recesses 222 (see FIG. 6 and FIG. 7). It is ensured as a result that the fluidic module 200 rotates 120 about the centre of rotation 122 at a predetermined rotational frequency when the arrangement 220 of recesses 222 is passed over by a flow of the first liquid 102 from radially outside to radially inside. This enables a controlled liquid front while the arrangement 220 of recesses 222 is passed over by a flow, and reduces the formation of air bubbles because it can be ensured by the delay, for example, that a centrifugal force acts on the first liquid 102 that is greater than a capillary force acting on the first liquid 102 due to a small chamber height 218 of the fluid chamber 210. In other words, the inlet structures 236 are designed to limit the liquid flow into the fluid chamber 210 in order to prevent that the first liquid 102 in the fluid chamber 210 reaches the arrangement 220 of recesses 222 before the centrifugal force acting on the first liquid 102 is greater than the capillary force acting on the first liquid 102 in the gap 218. A delay or limitation of this type can be implemented in that the inlet channel 232 is implemented as a resistance channel, for example, or the ventilation 238 is implemented as flow-restricting ventilation, for example, or ventilation 231 of the inlet chamber 230 is implemented as flow-limiting ventilation, for example.

If the inlet channel 232 is implemented as a resistance channel, i.e. as an inlet resistance channel, the latter limits a flow of the first liquid 102 from the inlet chamber 230 into the fluid chamber 210, i.e. a liquid flow into the fluid chamber 210 is limited. A cross section and a length of the inlet channel 232 are sized in such a manner, for example, that the first liquid 102 reaches the arrangement 220 of the recesses 222 within the fluid chamber 210 only when a predetermined rotational frequency is achieved during the rotation 120 for introducing the first liquid 102 into the fluid chamber 210. In an embodiment, inlet structures 236 which comprise an inlet resistance channel are combined with outlet structures 240 which comprise a volume-controlled switch, see the siphon 242 in FIG. 6. This enables a very efficient introduction 126 and removal 130 of the first liquid 102. Alternatively however, inlet structures 236 which comprise an inlet resistance channel could also be combined with outlet structures 240 which comprise an outlet resistance channel 244, see FIG. 7. However, it should be noted in this context that the outlet resistance channel 244 should be designed to limit the liquid flow to a greater extent than the inlet resistance channel.

If the ventilation 238 of the fluid chamber 210 is designed as flow-limiting ventilation, the latter limits a flow of the first liquid 102 from the inlet chamber 230 into the fluid chamber 210 in that the ventilation 238 during introducing 126 the first liquid 102 generates an overpressure in the fluid chamber 210, i.e. generates a pneumatic counter pressure in the fluid chamber 210. The ventilation 238, for example a cross section of a ventilation channel, is designed/sized in such a manner, for example, that the first liquid 102 reaches the arrangement 220 of the recesses 222 within the fluid chamber 210 only when a predetermined rotational frequency is reached during the rotation 120 for introducing the first liquid 102 into the fluid chamber 210. When inlet structures 236 which comprise flow-limiting ventilation are combined with outlet structures 240 which comprise a volume-controlled switch, see the siphon 242 in FIG. 6, the flow-limiting ventilation should be designed in such a manner that an overpressure generated by the latter in the fluid chamber 210 does not lead to the siphon 242 being prematurely exceeded. The siphon 242 and the flow-limiting ventilation should be adapted to one another in such a manner that the introduction 126 of the first liquid 102 into the fluid chamber 210 is indeed delayed but the arrangement 220 of recesses 222 is nevertheless completely passed over by a flow of the first liquid 102. Alternatively, inlet structures 236 which comprise flow-limiting ventilation could however also be combined with outlet structures 240 which comprise an outlet resistance channel 244, see FIG. 7. In this case, it is to be noted that the outlet resistance channel 244 should be designed to limit the liquid flow to a greater extent than the overpressure generated by the flow-limiting ventilation in the fluid chamber 210. In particular, the outlet resistance channel 244 and the flow-limiting ventilation should be adapted to one another in such a manner that the introduction 126 of the first liquid 102 into the fluid chamber 210 is indeed delayed but the arrangement 220 of recesses 222 is nevertheless completely passed over by a flow of the first liquid 102.

If the ventilation 231 of the inlet chamber 230 is designed as flow-limiting ventilation, the latter limits a flow of the first liquid 102 from the inlet chamber 230 into the fluid chamber 210 in that the ventilation 231, during introducing 126 the first liquid 102, generates a vacuum in the inlet chamber 230, i.e. generates a pneumatic vacuum in the inlet chamber 230. The ventilation 231, for example a cross section of a ventilation channel, is designed/sized in such a manner, for example, that the first liquid 102 reaches the arrangement 220 of the recesses 222 within the fluid chamber 210 only when a predetermined rotational frequency is reached during the rotation 120 for introducing 126 the first liquid 102 into the fluid chamber 210. When inlet structures 236 which comprise flow-limiting ventilation are combined with outlet structures 240 which comprise a volume-controlled switch, see the siphon 242 in FIG. 6, the flow-limiting ventilation should be designed in such a manner that a vacuum generated by the latter in the inlet chamber 230 does not lead to the siphon 242 being prematurely exceeded. The siphon 242 and the flow-limiting ventilation should be adapted to one another in such a way that the introduction 126 of the first liquid 102 into the fluid chamber 210 is indeed delayed but the arrangement 220 of recesses 222 is nevertheless completely passed over by a flow of the first liquid 102. Alternatively, inlet structures 236 which comprise flow-limiting ventilation could however also be combined with outlet structures 240 which comprise an outlet resistance channel 244, see FIG. 7. In this case, it is to be noted that the outlet resistance channel 244 should be designed to limit the liquid flow to a greater extent than the vacuum generated by the flow-limiting ventilation in the fluid chamber 210. In particular, the outlet resistance channel 244 and the flow-limiting ventilation should be adapted to one another in such a way that the introduction 126 of the first liquid 102 into the fluid chamber 210 is indeed delayed but the arrangement 220 of recesses 222 is nevertheless completely passed over by a flow of the first liquid 102.

When removing 130 the first liquid 102, the latter remains in the recesses 222 and is removed only from areas of the surface 216 outside the recesses 222 in order to generate the spatially separated liquid partitions 102ₚ of the first liquid 102 in the recesses 222 (see FIG. 6 and FIG. 7). As already mentioned above, the removal 130 of the first liquid 102 can take place by means of rotation 132, i.e. by rotating, the fluidic module 200 about the centre of rotation 122, so that the first liquid 102 is ejected from the fluid chamber 210. The first liquid 102 is removed from the fluid chamber 210 by way of the outlet 214. This is based on the fact that the siphon 242 in FIG. 6 after its apex 243 runs radially outwards, and also the alternative outlet resistance channel 244 in FIG. 7 runs radially outwards from the fluid chamber 210 and thus the centrifugal force acting on the first liquid 102 transports the first liquid 102 radially outwards from the fluid chamber 210. In the case of the siphon 242 in FIG. 6, for example, the apex 243 of the siphon 242 is exceeded at a point in time when introducing 126 the first liquid 102; consequently, the first liquid 102 within the siphon 242 is transported radially outwards and thus removed from the fluid chamber 210. The first liquid 102, during the removal 130 for example by way of the siphon 242 in FIG. 6 or by way of the outlet resistance channel 244 in FIG. 7, is transported into an overflow chamber 246 of the outlet structures 240. The overflow chamber 246 of the fluidic module 200 is disposed radially further outwards than the fluid chamber 210.

Optionally, the method 100 can furthermore comprise providing 140 a second liquid 104. The latter is provided in the inlet chamber 230, for example. The second liquid cannot be homogenously mixed with the first liquid and serves as a sealing liquid, for example.

After the first liquid 102 has been removed 130 from the fluid chamber 210, the cartridge, i.e. the fluidic module 200, could be stopped in order to introduce the second liquid 104 into the inlet chamber. Alternatively, the second liquid 104 could also be added under rotation by way of a further, automated process. A structure of the, for example extremely radially outward, overflow chamber 246, i.e. of the collection chamber, can be designed so as not to transport the first liquid 102 back into the inlet structure 236, or fluid chamber 210, in the moment of stoppage. The subsequent rotation 120 for introducing the second liquid 104 can ensure in a facilitating manner that the first liquid 102 continues to remain in the overflow chamber 246. This reduces contaminations of the inlet structure 236.

In an embodiment, the second liquid 104 in the method 100 is introduced 142 into the emptied fluid chamber 210 by means of rotating 120 the fluidic module 200 about the rotation axis 122, in order to seal the liquid partitions 102ₚ in the recesses 222. In other words, after the removal 130 of the first liquid 102, a second liquid 104, which cannot be homogenously mixed with the first liquid 102, is introduced into the fluid chamber 210 by rotating 120 the fluidic module 200.

As already mentioned above, a first embodiment is directed towards a combination of an inlet resistance channel with a filling level-coupled siphon 242, see FIG. 6. An array chamber, i.e. the fluid chamber 210, is completely filled from the inlet chamber 230, or until at least the arrangement 220 of recesses 222 has at least been completely passed over by a flow. A flow resistance between the inlet chamber 230 and the array chamber ensures that the filling of the recesses 222 is delayed after starting up the centrifuge and therefore takes place only at a sufficiently high rotational frequency (i.e. centrifugal force). The filling level is controlled by way of the siphon 242, which enables emptying of the fluid chamber 210 into a third chamber (overflow chamber 246) only once the array chamber has been entirely filled, or only once at least the arrangement 220 of recesses 222 has been at least completely passed over by a flow. Subsequently, the array chamber can be filled with a second liquid 104 in order to seal the recesses 222. In a similar embodiment, the third chamber can be upgraded with a further, radially inner chamber, because invading second liquid 104 can displace the first liquid 102 from the overflow chamber 246 due to differences in terms of density.

As likewise already mentioned above, a second embodiment is directed towards a resistance channel at the outlet 214, i.e. towards an outlet resistance channel 244, see FIG. 7. A fluid chamber 210 (array chamber) with a locally delimited array, i.e. with a locally delimited arrangement 220 of recesses 222, is completely filled from the inlet chamber 230, or until at least the arrangement 220 of recesses 222 has at least completely been passed over by a flow. The filling level is controlled by way of the resistance of the outlet channel, i.e. by way of the outlet resistance channel 244, in order to enable temporary complete filling of the fluid chamber 210, or complete filling of all recesses 222 of the arrangement 220 of recesses 222. For this purpose, the first liquid 102 should flow into the array chamber at a substantially faster rate than said liquid can flow out through the outlet 214. Nevertheless, as described above, a great centrifugal force should already be present when the first liquid 102 flows into the array chamber. This can be implemented, for example, by a very rapidly starting-up centrifuge, by an inlet resistance channel, by a volume-coupled siphon after the inlet chamber 230, i.e. between the inlet chamber 230 and the fluid chamber 210, or by flow-limiting ventilation 238. Subsequently, the array chamber is filled with a second liquid 104, for example, in order to seal the recesses 222. In a similar embodiment, the overload chamber 246 can be upgraded with a further, radially inner chamber, because invading second liquid 104 can displace the first liquid 102 from the overflow chamber 246 due to differences in terms of density.

Further embodiments are based on the flow-restricted ventilation of the fluid chamber 210 already mentioned above, i.e. the ventilation 238 is implemented as flow-restricted ventilation. The fluid chamber 210 (array chamber) with a locally delimited array, i.e. with a locally delimited arrangement 220 of recesses 222, is completely filled from the inlet chamber 230, or until at least the arrangement 220 of recesses 222 has been at least completely passed over by a flow. The filling level is controlled by way of the flow-restricted resistance of the array chamber ventilation 238 in order to enable temporary complete filling of the fluid chamber 210, or complete filling of all recesses 222 of the arrangement 220 of recesses 222. For this purpose, the siphon 242, see FIG. 6, should be configured in such a manner that an air overpressure occurs when filling the array chamber, this however does not lead to the siphon 242 being prematurely exceeded. In a combination of flow-restricted ventilation and the resistance channel at the outlet 214, i.e. the outlet resistance channel 244, see FIG. 7, the resistance of the outlet resistance channel 244, or the ratio of resistance of the outlet resistance channel 244 to a resistance caused by the flow-restricted ventilation at the inlet 212, should be chosen in such a way that an air overpressure is created in the array chamber during filling (due to the flow-restricted ventilation), on the one hand, and the array chamber is temporarily filled on the other hand, in order to fill all recesses 222 with the first liquid 102 (due to the resistance channel at the outlet 214).

The present invention achieves the general advantages of geometrically defined systems in comparison to droplet-based systems, as have already been explained in the introduction of the present application. The following points relate to the advantages of the invention in comparison to existing geometrically defined systems in conventional technology:
The invention enables particularly low costs per microfluidic module, because the device can be implemented completely in plastic, i.e. the fluidic module 200 can comprise plastics material. As opposed to typical systems in conventional technology, expensive materials such as glass or silicon in the chip can be dispensed with.
The filling of a large number of recesses 222 can take place very rapidly, because this is carried out in a planar manner, i.e. without individual supply channels. Owing to this fact, an almost unlimited number of recesses 222 can be filled in an acceptable time, because resistances in supply channels are dispensed with. Problems caused by adsorption of biomolecules on channel walls are likewise minimized as a result.
The method 100 enables a high spatial integration density of the recesses 222 because, as opposed to conventional technology, no connection channels are needed between the recesses 222.
Due to the use of centrifugal force for filling the recesses 222, hydrophilization or hydrophobization is not required for filling. This saves costs in production and enables the use of liquids with different contact angle properties.
A central advantage in comparison to conventional technology is the highly reduced dead volume. The interfering capillary forces are overcome by centrifugal forces, and defined filling of the recesses 222 can be achieved despite a small gap 218 in the array chamber, i.e. the fluid chamber 210. A reduced dead volume is essential in many applications, for example in order to make savings in terms of valuable specimens or costly reagents.

The device proposed here, i.e. the fluidic module 200, and the method 100 allow the microfluidic filling of planar arrangements 220 of recesses 222 with a particularly small dead volume. The person skilled in the art would either use droplet-based systems (see above for disadvantages) or accept the large dead volume of well-based systems.

Moreover, it is surprising that no instabilities of the partitions 102ₚ are observed in the described method 100 for filling and sealing the recesses 222. Under centrifugation, it would be expected that the first liquid 102, which advantageously comprises a lower density, rises in the environment of the second liquid 104, which advantageously comprises a higher density.

Additional embodiments and aspects which can be used individually or in combination with the features and functions described herein will be described hereunder.

One embodiment relates to a device, i.e. a fluidic module 200, which comprises geometrically defined recesses 222 for singularizing particles and/or molecules. The recesses 222 can be filled using centrifugal forces.

In order to achieve high centrifugal forces when entering a liquid, for example the first liquid 102, into the fluid chamber 210, the fluidic module 200 can
comprise a resistance channel, i.e. the inlet resistance channel, or
be designed to exert a pneumatic counter pressure on the liquid to be introduced, for example by way of the flow-restricted ventilation of the fluid chamber, or
be designed to exert a pneumatic vacuum on the liquid to be introduced, for example by way of the flow-restricted ventilation of the inlet chamber, or
comprise a volume-controlled switch, for example the siphon 242, or
comprise a very rapidly accelerating centrifuge.

One embodiment relates to a device, i.e. a fluidic module 200, which comprises the geometrically defined recesses 222 for singularizing particles and/or molecules in a fluidic part and/or in a cover part of the fluidic module 200.

A, for example initial, generation of the recesses 222 takes place, for example, by means of photolithography, interference lithography, laser lithography, micromilling, laser machining, electric discharge machining, chemical methods such as etching processes, roll methods such as roll-to-roll, roll-to-foil, roll-to-plate, or additive methods such as 2D or 3D printing methods.

Optionally, the device, i.e. the fluidic module 200, is completely manufactured from plastic.

According to an embodiment, the recesses 222 of the arrangement 220 of recesses 222 are limited to a defined area of the fluidic module 200, i.e. to a limited area on the surface 216 of the fluid chamber 210 of the fluidic module 200. Alternatively, the arrangement 220 of recesses 222 can extend across the entire surface 216, i.e. the recesses 222 are completely distributed across a single surface 216, i.e. a surface 216 of an internal wall of the fluid chamber 210.

The recesses 222 can be shaped, for example, to be round, rectangular, pyramidal, cylindrical, hemispherical, as spherical segments, conical, frustoconical, frustopyramidal, half-elliptic, as elliptic segments, prismatic and/or cuboid.

In one embodiment, recesses 222 of different sizes or volumes and/or different geometries are combined.

A further embodiment relates to a method 100 wherein the filling of the recesses 222 with a first liquid 102, i.e. the introduction 126 of the first liquid 102, and sealing of said recesses with a second liquid 104, i.e. the introduction 142 of the second liquid 104, takes place by the arrangement 220 of recesses 222 being passed over by a flow in a planar manner.

For example, the first liquid 102 comprises a reaction mix for detecting nucleic acids or a reaction mix for detecting proteins and/or metabolites.

For example, the second liquid 104 is a mineral oil or a synthetic oil.

Optionally, for carrying out a reaction, the fluidic module 200 is impinged with a defined temperature (isothermal assay). The fluidic module 200 can comprise, for example, a heater or cooler which is designed to bring the liquid partitions 102ₚ in the recesses 222 of the fluid chamber 210 to the predetermined temperature. Optionally, for carrying out the reaction, the fluidic module 200 is impinged with a temperature profile (thermocycling assay).

The reaction in the partitions 102ₚ can be observable in real time. Optionally, the reaction in the partitions 102ₚ is evaluated at an endpoint.

Optionally, the method 100 comprises removing products of the reaction from the partitions 102ₚ.

The liquid, for example the first liquid 102, which is divided into the liquid partitions 102ₚ can comprise, for example, molecules, such as nucleic acids, proteins and/or metabolites. Additionally or alternatively, the liquid, for example the first liquid 102, which is divided into the liquid partitions 102ₚ, can comprise particles, such as cells, extracellular vesicles and/or beads.

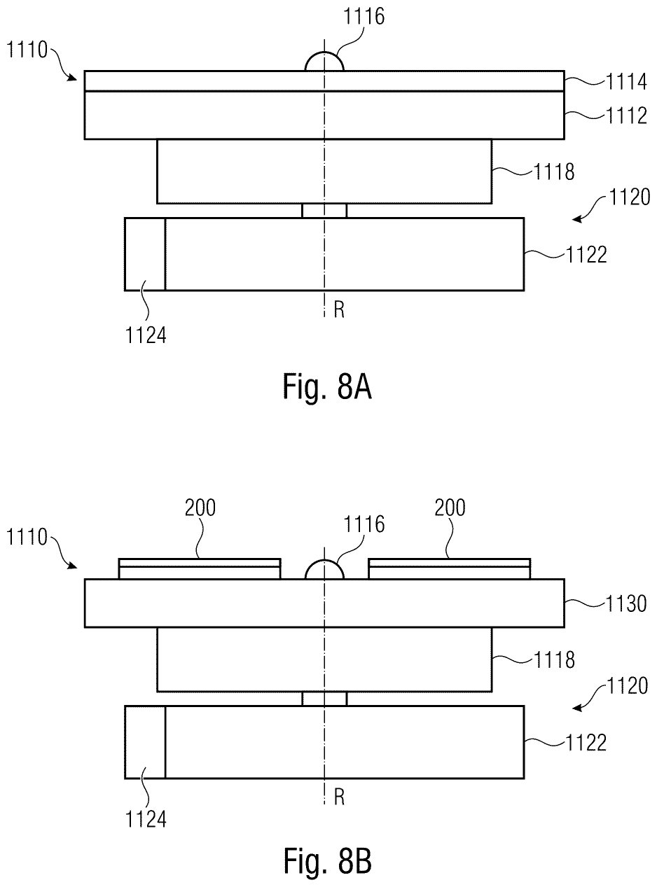

Referring to FIGS. 8A and 8B, examples of fluid handling devices in the form of centrifugal-microfluidic systems according to examples of the invention, which use or comprise a fluidic module 200 as described herein, will now be described. In other words, the fluidic module 200 in the systems in FIGS. 8A and 8B can be an arbitrary one of the fluidic modules described herein.

FIG. 8A shows a fluid handling device with a fluidic module 200 in the form of a rotational solid 1110 which comprises a substrate 1112 and a cover 1114. In top view, the substrate 1112 and the cover 1114 can be circular, with a central opening by way of which the rotational solid 1110 can be attached by way of a customary fastening installation 1116 to a rotating part 1118 of a drive device 1120. The rotating part 1118 is rotatably mounted on a stationary part 1122 of the drive device 1120. The drive device 1120 can be, for example, a conventional centrifuge, which may comprise an adjustable rotating speed, or else a CD or DVD drive. A control installation 1124, which is configured to control the drive device 1120 in order to impinge the rotational solid 1110 with a rotation or with rotations of different rotational frequencies, can be provided. As is obvious to a person skilled in the art, the control installation 1124 can be implemented, for example, by a correspondingly programmed computer installation or an application-specific integrated circuit. Furthermore, the control installation 1124 can be configured to control the drive device 1120 based on manual inputs by a user, so as to cause the needed rotations of the rotational solid. In any case, the control installation 1124 can be configured to control the drive device 1120 in order to impinge the rotational solid with the needed rotation in order to implement examples of the invention as described herein. A conventional centrifuge with only one rotation direction can be used as the drive device 1120.

The rotational solid 1110 comprises the fluidic structures which form the fluidic modules 200 as described herein. The fluidic structures can be formed by cavities and channels in the cover 1114, the substrate 1112, or in the substrate 1112 and the cover 1114. The substrate is also referred to herein as a fluidic part, and the cover is also referred to herein as a cover part. In examples, fluid structures can be reproduced in the substrate 1112, for example, while filling openings and ventilation openings are formed in the cover 1114. In examples, the structured substrate (including filling openings and ventilation openings) is disposed at the top and the cover is disposed at the bottom.

In an alternative example shown in FIG. 8B, fluidic modules 200 are inserted into a rotor 1130 and, conjointly with the rotor 1130, form the rotational solid 1110. The fluidic modules 200 can in each case comprise one substrate and one cover, in which in turn corresponding fluidic structures can be formed. The rotational solid 1110 formed by the rotor 1130 and the fluidic modules 200 is in turn able to be impinged with a rotation by the drive device 1120, which is controlled by the control installation 1124.

In FIGS. 8A and 8B, the centre of rotation about which the fluidic module, or the rotational solid, is rotatable is again denoted by R.

In examples of the invention, the fluidic module, or the rotational solid, which comprises the fluidic structures can be formed from any arbitrary suitable material, for example a plastic, such as PMMA (polymethyl methacrylate), PC (polycarbonate), PVC (polyvinyl chloride) or PDMS (polydimethylsiloxane), glass or the like. The rotational solid 1110 can be considered to be a centrifugal-microfluidic platform. In preferred examples, the fluidic module, or the rotational solid, can be formed from a thermoplastic, such as, for example, PP (polypropylene), PC, COP (cyclic olefin polymer), COC (cyclic olefin copolymer) or PS (polystyrene).

In examples, the drive device 1120 and an arbitrary one of the fluidic modules 200 described herein form an example of a fluid handling device according to the invention. In examples, the drive device 1120 is configured, for example controlled by the controller 1124, to rotate in a first phase the fluidic module 200 at a rotational frequency in order to exert a centrifugal force on a liquid 102, through which the liquid 102 is introduced into the fluid chamber 210 of the fluidic module 200, and through which at least part of the liquid 102 is transported from radially outside to radially inside across the arrangement 220 of recesses 222 within the fluid chamber 210, and continue to rotate in a second phase the fluidic module 200 at the rotational frequency or to increase the rotational frequency in order to remove the liquid 102 from areas of the surface 216 outside the recesses 222.

In examples, the drive device 1120 is configured to carry out a method 100 as has been described above with reference to FIGS. 1 to 7. Examples of the present invention achieve corresponding methods 100 for effectively generating spatially separated liquid partitions. Such methods 100 can be carried out while using fluidic modules and fluid handling devices as described herein.

Even though features of the invention have in each case been described by means of device features or method features, it is obvious to a person skilled in the art that corresponding features can in each case also be a constituent part of a method or of a device. Thus, the device can in each case be configured to carry out corresponding method steps, and the respective functionality of the device can represent corresponding method steps.

In the detailed description above, different features in examples have in some instances been grouped together in order to rationalize the disclosure. This type of disclosure is not to be interpreted to mean that the claimed examples comprise more features than expressly set forth in each claim. Instead, as reflected in the following claims, the subject matter can be present in fewer than all features of an individual disclosed example. Consequently, the following claims are incorporated hereby into the detailed description, wherein each claim can stand as a single separate example. While each claim can stand as a single separate example, it is to be noted that, even though dependent claims in the claims refer back to a specific combination with one or more other claims, other examples also comprise a combination of dependent claims with the subject matter of any other dependent claim or a combination of each feature with other dependent or independent claims.

Such combinations are to be included, unless it is explained that a specific combination is not intended. Furthermore, it is intended that a combination of features of one claim with any other independent claim is also included, even if this claim is not directly dependent on the independent claim.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

REFERENCES

| | |
|---|---|
| [Witters_2014] | Witters et al., Digital biology and chemistry, Lab Chip, 2014, 14, |
| | 3225-3232 |
| [Kivioja_2012] | Kivioja et al., Counting absolute numbers of molecules using |
| | unique molecular identifiers, Nature Methods volume 9, pages |
| | 72-74 (2012) |
| [Schulz_2021] | Schulz et al., High Dynamic Range Digital Assay Enabled by |
| | Dual-Volume Centrifugal Step Emulsification, Anal. Chem. |
| | 2021, 93, 5, 2854-2860 |
| [Schuler_2015] | Schuler et al., Centrifugal step emulsification applied for |
| | absolute quantification of nucleic acids by digital droplet RPA, |
| | Lab Chip, 2015, 15, 2759-2766 |
| [Teh_2008] | Teh et al., Droplet microfluidics, Lab Chip, 2008, 8, 198-220 |
| [Bio-Rad_2023] | Bio-Rad QX200, https://www.bio-rad.com/de-de/life- |
| | science/digital-pcr/qx200-droplet-digital-pcr-system, website |
| | accessed Jan. 3, 2023 |
| [Stilla_2023] | Stilla Naica, https://www.stillatechnologies.com/multiplex- |
| | pcr/digital-pcr/, website accessed Jan. 3, 2023 |
| [Liao_2017] | Liao et al., Digital PCR: Endless Frontier of ‘Divide |
| | and Conquer, Micromachines 2017, 8, 231 |
| [QIAGEN_2023] | QIAGEN QIAcuity, https://www.qiagen.com/de- |
| | de/applications/digital-pcr/products, website accessed |
| | Jan. 3, 2023 |
| [Quanterix_2023] | Quanterix Simoa, https://www.quanterix.com/simoa-technology/, |
| | website accessed Jan. 3, 2023 |
| [ThermoFisher_2023_1] | ThermoFisher QuantStudio Absolute Q, |
| | https://www.thermofisher.com/de/de/home/life- |
| | science/pcr/digital-pcr/quantstudio-absolute-q- |
| | system.html, website accessed Jan. 3, 2023 |
| [ThermoFisher_2023_1] | ThermoFisher QuantStudio 3D Digital PCR System, |
| | https://www.thermofisher.com/de/de/home/life- |
| | science/pcr/digital-pcr/quantstudio-3d-digital-pcr- |
| | system-emea.html, website accessed Jan. 3, 2023 |
| [Fluidigm_2023] | Fluidigm Digital Array IFC for Digital PCR, |
| | https://store.standardbio.com/ccrz_{——}ProductDetails?sku=BMK- |
| | M-48.770&cclcl=en_US, website accessed Jan. 3, 2023 |
| [JN-MEDSYS_2023] | JN MEDSYS Clarity Digital PCR, |
| | https://www.jnmedsys.com/clarity-digital-pcr/, website |
| | accessed Jan. 3, 2023 |
| [Roche_2023] | Roche Digital LightCycler, |
| | https://diagnostics.roche.com/global/en/products/systems/digit |
| | al-lightcycler-system-sys-362.html, website accessed |
| | Jan. 3, 2023 |
| [Illumina_2023] | Illumina Microarray Technology, |
| | https://www.illumina.com/science/technology/microarray.html, |
| | website accessed Jan. 3, 2023 |
| [Podbiel_2021] | Podbiel et al., Fusing MEMS technology with lab-on-chip, |
| | Microsystems & Nanoengineering (2020) 6: 82 |
| [Henley_2020] | Henley et al., Spatially isolated reactions in a complex array: |
| | using magnetic beads to purify and quantify nucleic acids with |
| | digital and quantitative realtime PCR in thousands of parallel |
| | microwells, Lab Chip, 2020, 20, 1771-1779 |
| [U.S. Pat. No. 8,277,759B2] | University of Utah, U.S. Pat. No. 8,277,759 B2, MICROFLUIDIC |
| | FLOW CELL |
| [U.S. Pat. No. 9,487,822B2] | Fluidigm, Us. Pat. No. 9,487,822 B2, METHOD AND |
| | APPARATUS FOR DETERMINING COPY NUMBER |
| | VARATION USING DIGITAL PCR |
| [EP3357575B1] | Roche, Patent EP 3 357 575 B1, SEALABLE MICROFLUIDIC |
| | CHIP AND METHOD FOR THERMOCYCLING |
| [U.S. Pat. No. 10,967,370B2] | Roche, U.S. Pat. No. 10,967,370 B2, MICROFLUIDIC DEVICE |
| | AND METHOD FOR MANUFACTURING THE SAME |
| [2012_Kan] | Kan et al., Isolation and detection of single molecules on |
| | paramagnetic beads using sequential fluid flows in |
| | microfabricated polymer array assemblies, Lab Chip, 2012, 12, |
| | 977 |
| [WO2021211754A2] | QUANTERIX CORP, Patent WO 2021/211754 A2, |
| | METHODS AND SYSTEMS RELATED TO HIGHLY |
| | SENSITIVE ASSAYS AND DELIVERING CAPTURE |
| | OBJECTS |
| [WO2012103447A1] | QUANTERIX CORP, Patent WO 2012/103447 A1, |
| | SYSTEMS, DEVICES, AND METHODS FOR ULTRA- |
| | SENSITIVE DETECTION OF MOLECULES OR PARTICLES |
| [2010_Rissin] | Rissin et al., Single-molecule enzyme-linked immunosorbent |
| | assay detects serum proteins at subfemtomolar concentrations, |
| | nature biotechnology, 2010, 28, 595-599 |

1. A method for generating spatially separated liquid partitions in an arrangement of recesses formed in a surface, comprising:
providing a fluidic module;
rotating the fluidic module comprising a fluid chamber that comprises the surface in which the arrangement of recesses is formed, about a centre of rotation in order to apply a centrifugal force on a liquid through which the liquid is introduced into the fluid chamber and through which at least part of the liquid is transported from radially outside to radially inside across the arrangement of recesses; and
removing the liquid from areas of the surface outside the recesses to generate the spatially separated liquid partitions of the liquid in the recesses.

2. The method according to claim 1, wherein the liquid in the areas outside the recesses is removed from the fluid chamber by way of an outlet by rotating the fluidic module, wherein, after the removal, a second liquid which cannot be homogeneously mixed with the liquid is introduced into the fluid chamber by rotating the fluidic module in order to seal the recesses with the liquid partitions comprised therein.

3. The method according to claim 1, wherein the fluid chamber forms a gap between the surface in which the arrangement of recesses is formed and a surface lying opposite this surface, wherein rotating the fluidic module is performed at such a rotating speed that the centrifugal force acting on the liquid volume is greater than the capillary force acting on the liquid in the gap.

4. The method according to claim 1, wherein a liquid flow into the fluid chamber is limited when introducing the liquid into the fluid chamber.

5. The method according to claim 3, wherein a liquid flow into the fluid chamber is limited when introducing the liquid into the fluid chamber, wherein it is prevented by limiting the liquid flow into the flow chamber that the liquid in the fluid chamber reaches the arrangement of recesses before the centrifugal force acting on the liquid volume is greater than the capillary force acting on the liquid in the gap.

6. The method according to claim 4, which uses an inlet resistance channel in the fluidic module that opens into the fluid chamber in order to limit the liquid flow into the fluid chamber.

7. The method according to claim 4, wherein a pneumatic counter pressure is generated in the fluid chamber in order to limit the liquid flow into the fluid chamber.

8. The method according to claim 7, wherein the pneumatic counter pressure is caused by flow-restricted ventilation of the fluid chamber.

9. The method according to claim 4, wherein a pneumatic vacuum is generated in the inlet chamber in order to limit the liquid flow into the fluid chamber.

10. The method according to claim 9, wherein the pneumatic vacuum is caused by flow-restricted ventilation of the inlet chamber.

11. The method according to claim 1, wherein a volume-controlled switch which is fluidically coupled to a or the outlet of the fluid chamber and enables emptying of the fluid chamber only once the arrangement has been completely passed over by a flow of the liquid is used.

12. The method according to claim 1, wherein an outlet resistance channel which is fluidically coupled to a or the outlet of the fluid chamber and prevents emptying of the fluid chamber until the arrangement has been completely passed over by a flow of the liquid is used.

13. A fluidic module for generating spatially separated liquid partitions while using a method according to claim 1, comprising;
the fluid chamber that comprises the surface in which the arrangement of recesses is formed;
inlet structures which are designed, during rotation of the fluidic module, to introduce liquid into the fluid chamber by means of centrifugal force in order to transport the liquid from radially outside to radially inside across the arrangement of recesses; and
outlet structures which are designed, after a flow has passed over the surface in which the arrangement of recesses is formed, to remove the same liquid from areas of the surface outside the recesses in order to generate the spatially separated liquid partitions of the liquid in the recesses.

14. The fluidic module according to claim 13, wherein the fluid chamber forms a gap between the surface in which the arrangement of recesses is formed and a surface lying opposite this surface, wherein a gap height of the gap is at most 10 times the depth of the recesses and/or the gap height is at most 200 μm, advantageously at most 100 μm.

15. The fluidic module according to claim 13, wherein the inlet structures comprise an inlet chamber which is at least in part disposed radially further inwards than an innermost portion of the arrangement of recesses, and a fluid channel which connects the inlet chamber to the fluid chamber.

16. The fluidic module according to claim 13,
wherein the inlet structures comprise an inlet resistance channel which is designed to limit the liquid flow into the fluid chamber, or
wherein the fluid chamber comprises flow-restricted ventilation which is designed, when introducing the liquid into the fluid chamber, to generate a pneumatic counter pressure in the fluid chamber in order to limit the liquid flow into the fluid chamber, or
wherein the inlet chamber comprises flow-restricted ventilation which is designed, when introducing the liquid into the fluid chamber, to generate a pneumatic vacuum in the inlet chamber in order to limit the liquid flow into the fluid chamber.

17. The fluidic module according to claim 13, wherein the outlet structures comprise a volume-controlled switch which enables emptying of the fluid chamber only once the arrangement has been completely passed over by a flow of the liquid, or an outlet resistance channel which prevents emptying of the fluid chamber until the arrangement has been completely passed over by a flow of the liquid.

18. A device for performing a method for generating spatially separated liquid partitions in an arrangement of recesses formed in a surface, the method comprising:
providing a fluidic module;
rotating the fluidic module comprising a fluid chamber that comprises the surface in which the arrangement of recesses is formed, about a centre of rotation in order to apply a centrifugal force on a liquid through which the liquid is introduced into the fluid chamber and through which at least part of the liquid is transported from radially outside to radially inside across the arrangement of recesses; and
removing the liquid from areas of the surface outside the recesses to generate the spatially separated liquid partitions of the liquid in the recesses,
comprising:
a fluidic module according to claim 13;
a drive installation for rotating the fluidic module.
